(19) United States
(12) Patent Application Publication
(10) Pub. No.: US 2011/0111201 A1
(43) Pub. Date: May 12, 2011

(54) Method of making coiled and buckled electrospun fiber structures and uses for same

(76) Inventors: Darrell H. Reneker, Akron, OH (US); Tao Han, Akron, OH (US)

(21) Appl. No.: 12/315,153

(22) Filed: Nov. 28, 2008

Related U.S. Application Data
(63) Continuation of application No. 12/161,451, filed on Aug. 29, 2008.
(60) Provisional application No. 60/990,495, filed on Nov. 27, 2007.
(60) Provisional application No. 60/760,867, filed on Jan. 20, 2006.

(51) Int. Cl. B32B 5/02; B29C 47/00; B29C 53/32; B05D 5/12

(52) U.S. Cl. 428/222; 264/465; 425/334; 427/58

(57) ABSTRACT

The present invention relates generally to methods to produce various desired patterns (e.g., coils) via an electrospinning process where such desired patterns possess certain desired properties (e.g., desired electrical properties). In one embodiment, the present invention relates to a method for producing coiled fiber patterns at a rate of one turn of the coil in a set time period (e.g., about one microsecond). In another embodiment, the present invention relates to methods to produce “resonator structures” that are the basic element of artificial dielectrics. In still another embodiment, the present invention relates to methods to produce coils with various specified diameters (e.g., about 10 microns) which can, among other things, enable the production of repeating patterns in a wallpaper-like array. In still yet another embodiment, the present invention relates to methods to hierarchical structures that offer mechanical support for various nanofibers.

### RELATED APPLICATION DATA

This application claims priority to and is a continuation-in-part of: (i) U.S. Provisional Patent Application No. 60/990,495, filed Nov. 27, 2007; and (ii) U.S. patent application Ser. No. 12/161,451, filed Jul. 18, 2008, which is a 35 U.S.C. §371 continuation of PCT Patent Application No. PCT/US2007/01590, filed Jan. 22, 2007, which claims priority to U.S. Provisional Patent Application No. 60/760,867, filed Jan. 20, 2006. All of the above-listed patent applications are hereby incorporated by reference in their entireties.

### FIELD OF THE INVENTION

The present invention relates generally to methods to produce various desired patterns (e.g., coils) via an electrospinning process where such desired patterns possess certain desired properties (e.g., desired electrical properties). In one embodiment, the present invention relates to a method for producing coiled fiber patterns at a rate of one turn of the coil in a set time period (e.g., about one microsecond). In another embodiment, the present invention relates to methods to produce “resonator structures” that are the basic element of artificial dielectrics. In still another embodiment, the present invention relates to methods to produce coils with various specified diameters (e.g., about 10 microns) which can, among other things, enable the production of repeating patterns in a wallpaper-like array. In still yet another embodiment, the present invention relates to methods to hierarchical structures that offer mechanical support for various nanofibers.

### BACKGROUND OF THE INVENTION

This invention is related to the production of electrospun fibers having very small coils which possess characteristics of structural chirality and can be used as negatively refracting structures in photonics for the control of electromagnetic waves, or as mixtures of left- and right-handed coils for use as fibrous structures in medical applications.

The technique of electrospinning or electrostatic spinning, of liquids and/or solutions capable of forming fibers, has been described in a number of patents as well as in the general literature. The process of electrospinning generally involves the creation of an electrical field at the surface of a liquid. The resulting electrical forces create a jet of liquid which carries electrical charge. Thus, the liquid jets may be attracted to other electrically charged objects at a suitable electrical potential. As the jet of liquid elongates and travels, it will harden and dry. The hardening and drying of the elongated jet of liquid may be caused by cooling of the liquid (i.e., where the liquid is normally a solid at room temperature); evaporation of a solvent (e.g., by dehydration, physically induced hardening); or by a curing mechanism (e.g., chemically induced hardening). The produced fibers are collected on a suitably located, oppositely charged receiver and subsequently removed from it as needed, or directly applied to an oppositely charged generalized target area.

Fibers produced by such processes have been used in a wide variety of applications, such as in U.S. Pat. Nos. 4,043,331 and 4,878,908, are useful in forming non-woven mats suitable for use in wound dressings. These U.S. Patents make it clear that strong, non-woven mats can be made comprising a plurality of fibers of organic, namely polymeric, material produced by electrostatically spinning the fibers from a liquid consisting of the material or precursor. These fibers are collected on a suitably charged receiver and subsequently removed.

One of the major advantages of using electrospun fibers is that very thin fibers can be produced having diameters, usually on the order of about 50 nanometers to about 25 microns, or in another instance on the order of about 10 nanometers to about 5 microns. These fibers can be collected and formed into non-woven mats of any desired shape and thickness. It will be appreciated that because of the very small diameter of the fibers a mat with very small interstices and high surface area per unit mass can be produced.

Besides providing variability as to the diameter of the fibers or the shape, thickness, or porosity in any non-woven mat produced, the ability to electrospin the fibers also allows for variability in the composition of the fibers, their density at deposition, and their inherent strength. By varying the composition of the fibers being electrospun, it will be appreciated that fibers having different physical or chemical properties may be obtained. This can be accomplished either by spinning a liquid containing a plurality of components, each of which may contribute a desired characteristic to the finished product, or by simultaneously spinning, from multiple liquid sources, fibers of different compositions that are then simultaneously deposited to form a mat. The resulting mat, of course, would consist of intimately intermingled fibers of different material. Alternatively, it is possible to produce a mat having a plurality of layers of different fibers of different materials (or fibers of the same material but different characteristics, e.g., diameter), as by, for example, varying the type of fibers being deposited on the receiver over time.

The characteristics of the coils and arrays of coils created by the electrically driven bending instability (Darrell H. Reneker, Alexander L. Yarin, Hao Fong and Sureeporn Koombhongse, “Bending instability of electrically charged liquid jets of polymer solutions in electrospinning,” Journal of Applied Physics, Volume 87, pages 4531 to 4547, May, 2000.)

J. B. Pendry in Science, Volume 306, 19 Nov. 2004, pp. 1353 to 1355, in a paper entitled A Chiral Route to Negative Refraction, which is incorporated by reference, suggests that chiral resonances offer alternatives or advantages over negative refraction structures that are currently used. The terms chiral and chirality are usually used to describe an object which is non-superimposable on its mirror image. U.S. Pat. No. 7,106,918 teaches that structurally chiral materials can exhibit magneto-gyrotropy. The structural materials employed have at least one continuous structurally chiral material. Thus, these characteristics can lead to desirable properties and applications such as photonic structures or other applications.

### SUMMARY OF THE INVENTION

The present invention relates generally to methods to produce various desired patterns (e.g., coils) via an electrospinning process where such desired patterns possess certain desired properties (e.g., desired electrical properties). In one embodiment, the present invention relates to a method for producing coiled fiber patterns at a rate of one turn of the coil in a set time period (e.g., about one microsecond). In another embodiment, the present invention relates to methods to produce “resonator structures” that are the basic element of artificial dielectrics. In still another embodiment, the present invention relates to methods to produce coils with various specified diameters (e.g., about 10 microns) which can, among other things, enable the production of repeating patterns in a wallpaper-like array. In still yet another embodiment, the present invention relates to methods to hierarchical structures that offer mechanical support for various nanofibers.

In one embodiment, the present invention relates to a method of making coiled and buckled electrospun fibers comprising the steps of: (a) providing a solution of a polymer in a suitable solvent and a device for electrospinning fiber; (b) providing an electrospinning device; (c) subjecting the polymer solution to an electric field such that at least one fiber is electrospun; (d) subjecting the jet formed by the electrospinning device to electrical bending and mechanical buckling instability to thereby form a coiled and buckled fiber; and (e) collecting the at least one fiber on a collector, such that a fiber structure is produced.

In another embodiment, the present invention relates to an apparatus for electrospinning at least one polymer fiber comprising: (i) at least one reservoir; (ii) at least one device for electrospinning at least one fiber, the at least one device being in fluid communication with the at least one reservoir; (iii) a mixing device for agitating the fluid within the reservoir; (iv) a power source capable of generating an electric field in electrical communication with the at least one device; (v) means for electrically coiling and mechanically buckling said fibers; and (vi) means for collecting the electrospun fibers.

In still another embodiment, the present invention relates to a method of making coiled and buckled electrospun fibers comprising the steps of: (a) providing a solution of a polymer in a suitable solvent and a device for electrospinning fiber; (b) providing an electrospinning device; (c) subjecting the polymer solution to an electric field such that at least one fiber is electrospun; (d) subjecting the jet formed by the electrospinning device to electrical bending and mechanical buckling instability to thereby form a coiled and buckled fiber; (e) collecting the at least one fiber on a collector, such that a fiber structure is produced; and (f) coating the fiber structure on at least one surface thereof with at least one coating material.

In still yet another embodiment, the present invention relates to a method of making coiled and buckled electrospun fibers comprising the steps of: (A) providing a solution of a polymer and at least one type of magnetic and/or electrically-conductive particles in a suitable solvent and a device for electrospinning fiber; (B) providing an electrospinning device; (C) subjecting the solution to an electric field such that at least one fiber is electrospun; (D) subjecting the jet formed by the electrospinning device to electrical bending and mechanical buckling instability to thereby form a coiled and buckled fiber; and (E) collecting the at least one fiber on a collector, such that a fiber structure is produced, wherein the at least one fiber contains therein at least one type of magnetic and/or electrically-conductive particles.

### BRIEF DESCRIPTION OF THE DRAWINGS

FIG. 1 is a photograph of an electrospinning jet with bending instability;

FIG. 2 is a schematic drawing of an electrospinning setup with laterally movable tilted collector;

FIG. 3 is a series of digital camera photographic images of an electrospinning jet at different stages;

FIG. 4 is a series of optical microscopy images and scanning electron microscopy images of electrospun fibers;

FIG. 5 is a series of high speed camera images of the electrospun jet and showing the effect of time on the voltage lowering;

FIG. 6 is a series of optical microscopic pictures of buckled electrospun poly(L-lactide) (PLLA) fibers;

FIG. 7 illustrates a continuous electrospun PLLA fiber with helix and folds buckling;

FIG. 8 is a set of photographs of buckled and bent electrospun Nylon-6 deposits where the lengths of the horizontal edges of the images FIGS. 8a, 8b, 8d, 8e are 0.18 mm; the length of the horizontal edge of the image FIG. 8c is 6.0 mm, and the total change in the inter-electrode distance is about 0.3 cm from the left edge to the right edge in FIG. 8c;

FIG. 9 is a photograph showing buckling coils of Nylon-6 nanofibers superimposed on coils having electrical bending instability;

FIG. 10 is a photograph of a straight electrified jet, too short to develop an electrical bending instability;

FIG. 11 is an SEM image of some of the buckled PEO patterns collected on the horizontal collector which is moving at 0.785 m/s along the direction shown by the white arrow;

FIG. 12 is a set of optical micrographs of buckled bending electrospun PEO jets;

FIG. 13 is a set of optical micrographs of bent and buckled PEO loops and patterns collected at different inter-electrode distances on the surface of a moving and inclined collector (in all images the wedge moved at 0.01 m/s along the direction shown by the white wide arrow in FIG. 13a);

FIG. 14 is a set of optical images of buckled solidified PLLA patterns (in all images the horizontal collector is moved in direction shown by the black arrow in FIG. 14a where the distance A (the wavelength) corresponds to the lateral motion during one period of the formation of the buckling patterns);

FIG. 15 is a set of optical micrographs of buckled polystyrene patterns where the horizontal collector is moved in the direction shown by the black arrow in FIG. 15a;

FIG. 16 is a set of optical micrographs of buckled polystyrene patterns collected on a static water surface;

FIG. 17 is a set of photographs of three-dimensional buckled patterns formed after the impingement of a polystyrene jet onto a water surface (the samples are dipped from the water with a glass microscopic slide and observed with the optical microscopy);

FIG. 18 is a set of photographs of a comparison of the buckled patterns created by electrified jets of polyethylene oxide in water, collected on glass slides, to patterns produced by the buckling of uncharged gravity-driven syrup jets (note that the gravity-driven syrup jets and their buckling patterns are about 1000 times larger than those of the electrified jets of polyethylene oxide in water, where the upper panel in each pair depicts the results for the electrified PEO jets in the present work, and the lower panel shows the similar patterns by the syrup jets in Chiu-Webster et al., J Fluid Mech. 2006; 569: 89 to 111);

FIG. 19 is a set of photographs of a comparison of the buckled patterns created by electrified Nylon-6 jets collected on water to the buckling patterns in Chiu-Webster et al., J Fluid Mech. 2006; 569: 89 to 111 resulting from uncharged gravity-driven syrup jets; and

FIG. 20 is a set of photographs of a comparison of buckled patterns created by electrified Nylon-6 jets collected on a water surface.

### DETAILED DESCRIPTION OF THE INVENTION

The present invention relates generally to methods to produce various desired patterns (e.g., coils) via an electrospinning process where such desired patterns possess certain desired properties (e.g., desired electrical properties). In one embodiment, the present invention relates to a method for producing coiled fiber patterns at a rate of one turn of the coil in a set time period (e.g., about one microsecond). In another embodiment, the present invention relates to methods to produce “resonator structures” that are the basic element of artificial dielectrics. In still another embodiment, the present invention relates to methods to produce coils with various specified diameters (e.g., about 10 microns) which can, among other things, enable the production of repeating patterns in a wallpaper-like array. In still yet another embodiment, the present invention relates to methods to hierarchical structures that offer mechanical support for various nanofibers.

As is noted above, the present invention relies, in one embodiment, upon a coiling behavior in one or more electrospinning jets to permit the production of arrays of elements which have useful photonic behavior, including the ability to produce negative dielectric constant materials for a wide variety of uses. In one embodiment, the coiled structures of the present invention can be at least partially coated with one or more electrically-conductive materials in order to form electromagnetic resonator structures. Electrospinning jets coil in two modes, the electrically driven bending instability and the buckling phenomena that occur when a relatively fluid jet is collected at an interface.

In one embodiment, the present invention offers a way of manufacturing tiny coils with diameter dimensions that range from about 0.5 microns to about 1,000 microns. In another embodiment, the present invention offers a way of manufacturing tiny coils with diameter dimensions that range from about 1 micron to about 750 microns, or from about 3 microns to about 500 microns, or from about 5 microns to about 400 microns, or from about 7.5 microns to about 300 microns, or from about 10 microns to about 250 microns, or from about 25 microns to about 100 microns, or even from about 50 microns to about 75 microns. In another embodiment, the diameter of the coils produced via the methods of the present invention are in the range of about 10 nanometers to about 500 centimeters, or from about 1 micron to about 50 centimeters, or even from about 1 micron to about 500 microns. Here, as well as elsewhere in the specification and claims, individual range limits can be combined to form additional non-disclosed ranges.

The handedness (i.e., left-handed or right-handed) of the coils can be controlled to produce fibers having desirable characteristics and applications. The jet may coil by electrically driven bending, and if stopped on a collector form distinctive buckling coils on the collector. In some embodiments, the coiled structures of the present invention can be simultaneously coated with one or more materials such as those described in detail below (e.g., conductive materials).

Nanofibers (i.e., nanometer scale fibers) can be made via electrospinning by utilization of the electrically driven bending instability and/or mechanical buckling the coils to extend the negative refraction effects to shorter wavelength. One specific structure is coiled polymer fibers, which in some cases are augmented by strategically placed optically inhomogeneous coatings or inclusions.

In one embodiment, the buckling of the fibers of the present invention is achieved via the use of mechanical force so as to buckle one or more fibers produced by electrospinning. Additionally, in some embodiments, a transverse electric field can be applied at an appropriate frequency and direction to the jet which become the fiber as it approaches or is collected on the fiber collector. Since the buckling is done while the jet is still fluid, the fiber is formed after the jet is buckled.

The term electrical bending is intended to mean the bending of the jet which follows the onset of a characteristic instability of an electrified jet. Electrical bending is achieved principally by controlling the voltage applied in the electrospinning process, as well as, in some embodiments, the concentration and the viscosity of the fiber forming polymer.

The coiled structures of the present invention can be produced from coiled polymer. Such structures and/or fibers can further be coated with electrical conductors, metals, or magnetic coatings. Such coatings include, but are not limited to, at least one metal, at least one ceramic compound, at least one oxide compound, at least one conductive non-metal compound, or a combination of two or more thereof. In one embodiment, the at least one metal includes, but is not limited to, copper, gold, silver, platinum, palladium, iridium, or combinations of two or more thereof. In another embodiment, the at least one oxide compound includes, but is not limited to, one or more titanium oxides, one or more silicon oxides, one or more zinc oxides, or combinations of two or more thereof. In still another embodiment, the at least one conductive non-metal compound includes, but is not limited to, graphite or compounds that when process (e.g., via heating) produce graphite. The coils can be supported in a structure or material with contrasting electromagnetic properties to form sheets inside which the coils are randomly arranged or are arranged in arrays to direct electromagnetic waves or photons.

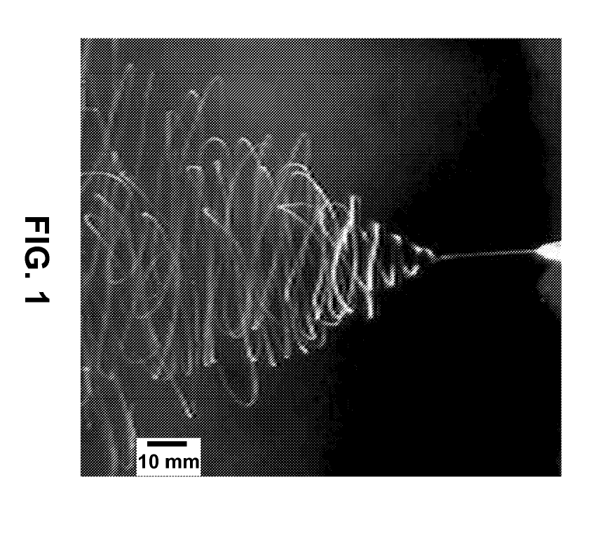

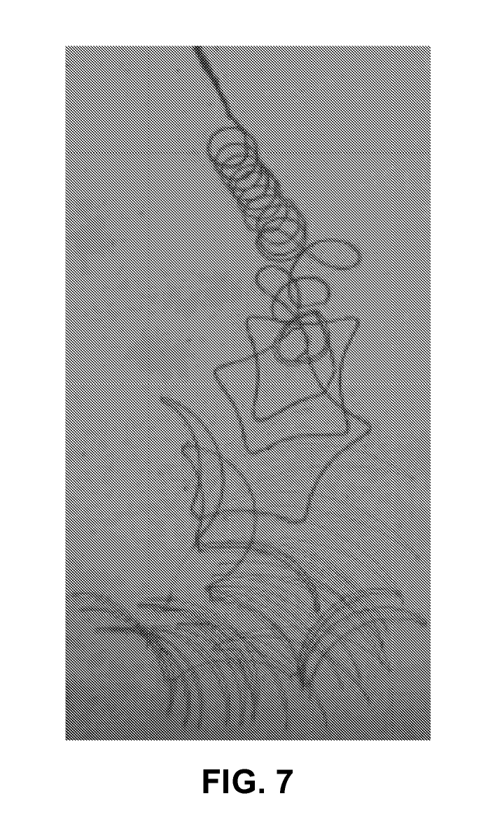

In one embodiment, electrospinning produces long arrays of regular coils such as those shown in FIG. 1. In one embodiment, the control and coating of these coils, as is shown in FIGS. 7, 8, and 9, leads to useful negatively refracting structures. The process is used to make uniform coils, testing for negative refraction effects, and useful devices. Partial coatings in regular patterns can also be applied to the polymer chords of the coils to enhance charge interactions with photons and/or other electromagnetic radiation. The coils can be made electrically conducting or magnetic by coating with evaporated metal via a wide variety of known deposition and/or coating processes.

Arrays of nanofibers in three dimensions have high dielectric contrast, which can be varied by changing the ratio of the diameter of the nanofibers to the spacing between the nanofibers. Any optimal spacing can be employed. In one embodiment, the optimal spacing is set by the wavelength of the light (e.g., 500 nm) to less than about 100 nm. Electrical forces inherent in electrospinning are utilized to make photonic arrays of straight nanofibers, or arrays of coiled nanofibers that can interact with circularly polarized radiation.

Methods for coating the polymer coils with metals and other material are known in the art, for example see: Wenxia Liu et al., Poly(Meta-Phenylene Isophthalamide) Nanofibers: Coating and Post Processing, Journal of Material Research, 17(12), pp. 3206 to 3212, (2002). Evaporation of the metal from one direction onto the coiled polymer nanofiber will create a metal “split ring resonator” equivalent to those described by Costas M. Soukoulis et al., Negative Refractive Index at Optical Wavelengths, Science Vol. 315, 5, pp. 47 to 49, (January 2007).

In another embodiment, the present invention enables the control of the resonant frequency of a coiled structure via the inclusion of magnetic particles that are dispersed in the polymer fibers that form the coiled structures of the present invention. Via the inclusion of such magnetic particles, it is possible to control the magnetic susceptibility of the coils in a coiled structure. In one embodiment, the magnetic particles utilized in conjunction with the present invention include, but are not limited to, particles formed from one or more magnetic metals (e.g., iron, nickel and/or cobalt particles), particles formed from one or more iron-bearing compounds (e.g., montmorillonite, nontronite (iron-rich clay), biotite (silicate), siderite (carbonate), and/or pyrite (sulfide)), particles formed from one or more magnetic alloys (e.g., magnetic alloys of iron, nickel and/or cobalt particles), particles formed from one or more ferrite compounds, or combinations of two or more thereof. The size of the particles is not limited to any specific range and 30′ thus is not critical so long as the particles can be incorporated into the fiber forming process. In one embodiment, the particles can be any size including, but not limited to, nano-sized particles. Furthermore, particles having various geometries can be utilized. Such particle geometries include, but are not limited to, needle-shaped, platelet-shaped, spherical, or a combination of any two or more different geometries.

The continuous and rapid formation of coils by buckling of an electrospinning jet offers advantages in the manufacture of photonic structures, particularly in the introduction of chirality of the coiled structure. Either left- or right-handed coils with diameters smaller than the wave length of the electromagnetic radiation that is to be acted upon can be generated. These can be as small as the wavelength of visible light or, by control of the buckling process, can be made on a larger scale. This control can be achieved by application of rotating electric fields that guide the direction of the onset of buckling to form either a left- or right-handed coil. Mechanical displacements of the collector in a radial direction followed, an appropriate time later, by a second displacement to the left or right can also control the handedness of the coil that develops. In another embodiment, static electric and/or magnetic fields with screw-like geometries can also be used to create the coiled structures of the present invention.

Devices which can supply transverse electric fields are simple and are known. See, for example, Pohl, H. A., Dielectrophoresis, Cambridge University Press (1978), the disclosure of which is incorporated herein by reference. These are simply an arrangement of electrical connections to give 90° phase difference between adjacent electrodes to produce a rotating electric field. The rotating electrical field is used to influence the handedness of the jet from the electrospinning apparatus in the beginning of the coiling of the jet as it approaches the collector.

The determination of the behavior of the jet path in the vicinity of the onset of the primary electrical bending instability is important for the orderly collection of nanofibers produced via electrospinning. A stable jet is observed with a high frame rate, short exposure time video camera. The collection process is complicated but predictable within limits, so the design and creation of some two or three dimensional structures of nanofibers is feasible, if the considerations described below are incorporated into the design and production processes.

The fluid jet in the straight segment of the path, and the more solid nanofibers in the coils of the primary electrical bending instability are collected on stationary and moving surfaces. The diameter and characteristic path of the jet depends on the exact distance between the orifice and the collector, provided other parameters are not changed. The moving surfaces cause the various coils that are collected to be displaced rather than superimposed. The fiber collected on the moving surfaces preserve a record of the electrical and mechanical instabilities that occur. If the straight segment is very fluid, the jet formed a series of small sessile drops on the collector, but when the jet is more solid, buckling occurs and produces small, complicated loops close to point at which the jet hits the surface. Buckling is observed during collection of the straight segment and the first coils of the electrically driven electrical bending instability. A moving inclined collector is used to collect the fibers. Surface velocities are up to about 5 meters per second. These velocities are commensurate with the velocities at which the solidifying jet approaches the surface. A variety of structures of loops, both conglutinated and not, associated with the instabilities are created.

The jets used in one embodiment of the present invention are formed from solutions of polyethylene oxide, Nylon-6, or polylactic acid. However, it should be noted that the present invention is not limited to just the polymers previously mentioned. Instead, any polymer that can be put into solution and electrospun can be used in conjunction with the present invention. Various solvents can be used for any given polymer of the present invention. As such, the jet path may change when the solvent utilized is altered or when the concentration of the solvent is changed. The jets form from a pendent drop on a glass capillary with an orifice diameter of about 160 microns. A potential difference in the range of about 500 to about 13,000 volts is applied between the orifice and the collector. The distance from the orifice to the grounded collector varied from about 1 mm to about 30 cm. Interference colors associated with jet diameters around 10 microns are observed in the straight segment. The color patterns are stable, indicating that the process variations are small.

The variety of buckling coils in this reference show that resonators based on rows of script “e”, rows of script “8”, and rows of semicircular bends, and more, can be used to construct more complicated resonators with different resonant frequencies, and with multiple resonances in each element.

The resonators can be arranged with chosen degrees of symmetry, for example translational symmetry, random positions in a plane, axial symmetry, mirror symmetry, and the like. The structures can be arranged to have resonance frequencies that change with position in a plane to provide spatial separation of different frequency bands, producing, in a different way, an effect somewhat like a prism separating colors in white light, or to perform a variety of other such functions. Three dimensional arrangements can be made by collecting the coils on a rotating cylinder, by processes used in the textile weaving industry, by multilayer of two dimensional arrays, and by three dimensional weaving processes.

### EXAMPLES

Fibers are made using polyethylene oxide (PEO) having a molecular weight of 400,000 g/mol via a 6 weight percent solution in distilled water; poly(L-lactide) (PLLA) having a molecular weight of 152,000 g/mol in a 5 weight percent solution in hexafluoroisopropanol (HFIP); and Nylon-6 as a 10 weight percent solution in HFIP and formic acid mixture, where the HFIP and Formic acid are in a weight ratio of 8:2. The high voltage power supply is a JEOL 5310 and the scanning electron microscopy is an Olympus 51BX Optical Microscopy.

A flash camera and a high speed camera that record up to 2000 images per second are used to record the morphology of the jet path. The polymer solutions are held in a glass pipette which has a 2 cm long capillary at one end. The capillary's inner diameter is 160 μm. A copper wire is immersed in the solution and connected with an adjustable high voltage power supply which could generate DC voltage up to about 13 KV. A grounded plate is placed from 1 mm to 300 mm below the orifice. The collector can be moved laterally at speeds of 0 to 5 m/s. The distance between the orifice and the collector is adjusted from 1 mm to 100 mm. The jet path follows the curved electric field lines, so that the actual length of the path is a little longer than the perpendicular distance between the plate and the orifice. The appearance of the collected fibers is not greatly changed by the inclination. An ammeter is connected between the collector and grounded wire to measure the current carried by the electrospinning jet. The collected fibers are observed with optical microscopy and scanning electron microscopy.

The electrospinning jet is a continuous fluid flow ejected from the surface of a fluid when the applied electrical force overcomes the surface tension. The jet moves straight away from the tip for some distance and then becomes unstable and bends into coiled loops as is shown in FIG. 1. This instability phenomenon is known as electrically driven bending instability. When the distance between the orifice and grounded collector is reduced to less than the length of the maximal straight segment observed with the collector far from the orifice, the electrical bending instability did not occur, instead, only a straight jet is produced.

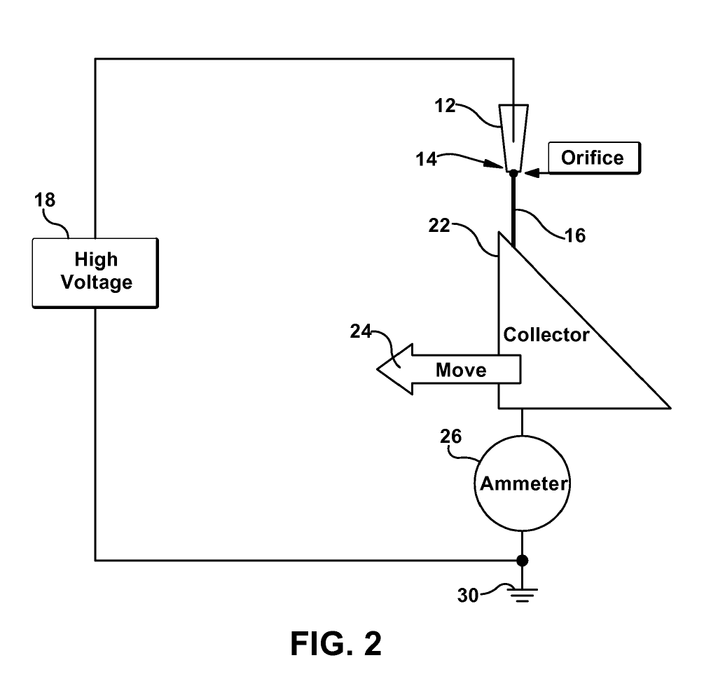

Bending instability as the function of distance is demonstrated by continuously increasing the distance from the tip to the collector. As seen in FIG. 2, electrospinning spinneret 12 is fed a polymer (not shown), which exits via orifice 14 as a stream 16. The electrostatic force supplied via a voltage source 18 and conductor 20. The effect of the electrostatic force causes the steam to become unstable and bend into coiled loops as shown in FIG. 1. Tilted grounded collector 22 is set beneath electrospinning spinneret 14. The distance from the tip to the collector is set as 1 mm and then the tilted collector is moved laterally as shown by arrow 24. Ammeter 26 is employed to measure and control the current flow.

The onset of the electrical bending instability is investigated by continuously increasing the distance from the orifice to the collector. An inclined grounded collector is placed beneath the electrospinning spinneret (FIG. 2). The perpendicular distance from the orifice to the collector is set at 1 mm and then the inclined collector is moved laterally. Using a 6 weight percent PEO aqueous solution the distance between the tip and the collector surface is continuously increased from 1 mm to 75 mm as the tilted collector moved. The voltage between the spinneret and the collector is 5.4 KV, while the diameter of the spinneret is 160 μm.

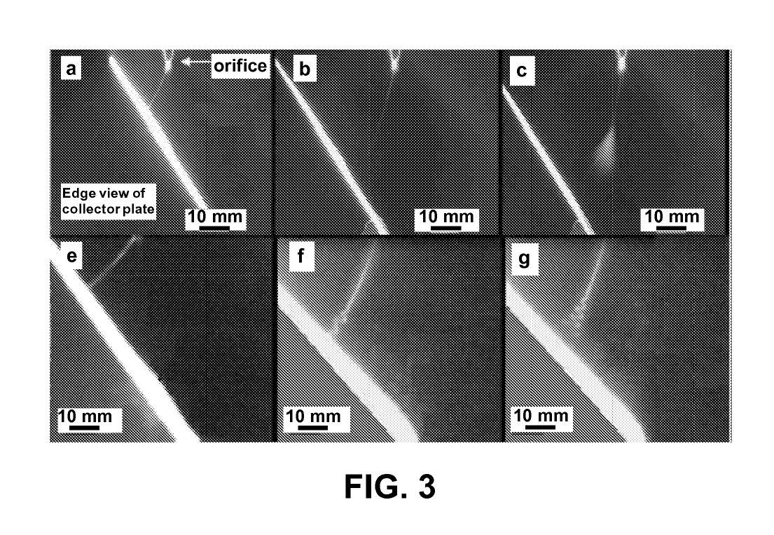

Digital camera and high speed camera were used to record the morphology of the electrospinning jet (see FIG. 3). A Fresnel lens produced a converging cone of illumination at the location of the electrospinning jet. The opaque disk on Fresnel lens prevents light from the arc lamp from entering the camera, but enough light is scattered by the jet entering the camera to observe the path of the jet.

FIG. 3 shows time averaged (a, b, c) and instantaneous (e, f, g) paths of the electrospinning jet at different distances between the orifice and the collector. When the jet leaves the orifice it moves to the collector and produces a straight jet. No electrical bending instability is observed when the orifice to collector distance is short. Both the digital camera image (FIG. 3a) and the high speed camera image (FIG. 3e) shows an essentially straight jet. When the distance increases to 53 mm in this experiment, the digital camera shows a blurred image (FIG. 3b) of the jet and the high speed camera image (FIG. 3f) shows that electrical bending instability has occurred. The coiled loops grow in radius and propagate along a slightly curved electric field line as they move downwards at a speed of about 2 to 5 m/s.

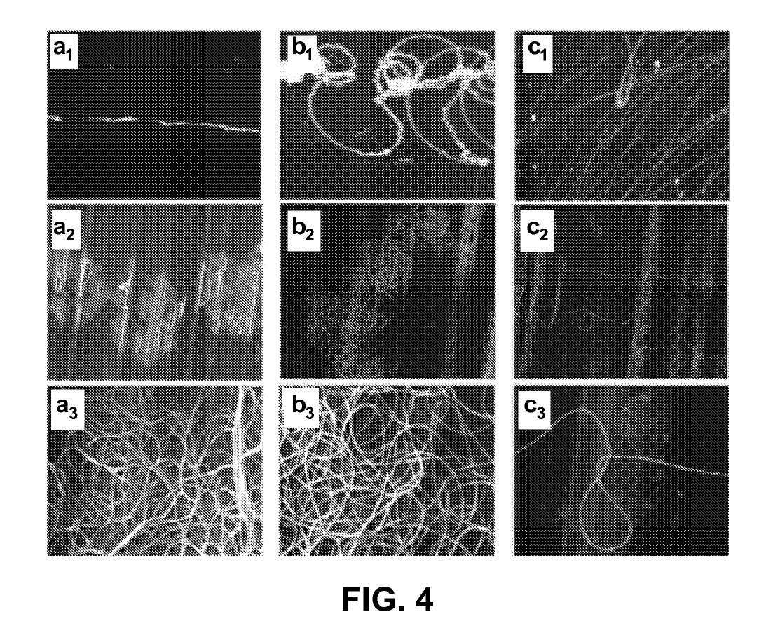

With increasing collection distance, the digital camera (FIG. 3c) shows interference colors indicating that the jet has a diameter of more than 10 micrometer at the top and about 2 micrometer at the onset of the electrical bending instability; the high speed camera (FIG. 3g) shows clearly the coiled loops of the electrical bending instability. Before the electrical bending instability, the path curves so that the jet approaches the plane of the collector in a more nearly perpendicular direction. In each repetition of this experiment, one single trace of the electrospun fiber is collected on the laterally moving collector. The optical and scanning electron microscopy images (FIG. 4a₁ to FIG. 4c₂) shows the changes in the collected fibers as the orifice to collector distance increased. The straight electrospinning jet produced conglutinated fibers and buckled fibers (FIG. 4a₁). These fiber segments have a wide diameter distribution that ranges from 300 nm to 1 μm (FIG. 4a₂). After the start of electrical bending instability, the jet produces loops (FIG. 4b₁) with diameters ranging from about 50 to about 200 μm. FIGS. 4b₂ and 4b₃ show short segments of the electrical bending instability coils in FIG. 4b₁ at a higher magnification. The amount of conglutination is smaller than that shown in FIGS. 4a₂ and 4a₃. The segments of fibers in FIG. 4c₁ are collected after the primary electrical bending instability loops are much larger than the area shown. The segments shown are only slightly curved. Some segments have nearly periodic curved shapes and small loops that are characteristic of buckling. FIG. 4c₃ show an enlarged image of a loop made by buckling.

TABLE 1

| | | | | | | | Length of | Wave |
|---|---|---|---|---|---|---|---|---|
| Instability | | Solution | | | Wavelength | Frequency | fiber in μm | Number |
| Mode | Figure | Polymer | Solvent | C % | μm/cycle | Cycles/sec | per cycle | Cycle/mm |
| Electrical Bending Coils | 1 | PEO | Water | 6 | | | | |
| | 3b, 3c, 3f, 3g | PEO | Water | 6 | | | | |
| | 4b₁, 4b₂ | PEO | Water | 6 | 48-200 | (0.5-2.1) × 10³ | 150-628 | 5-21 |
| | 4c₁ | PEO | Water | 6 | Buckling on bending loops | | | |
| | 5 | PEO | Water | 6 | | | | |
| | 8b | Nylon-6 | HFIP/FA | 10 | 29 | 3.45 × 10³ | 578 | 57 |
| | 8c | Nylon-6 | HFIP/FA | 10 | Superimposed bending and buckling | | | |
| | 8d | Nylon-6 | HFIP/FA | 10 | 55.3 | 1.81 × 10³ | 2101 | 18.1 |
| | 8e | Nylon-6 | HFIP/FA | 10 | 55 | 1.82 × 10³ | 4741 | 18.2 |
| Mechanical Buckling | 4a₂, 4a₃, 4b₂, | PEO | Water | 6 | | | | |
| Coils and Folds | 4b₃, 4c₁, 4c₂, | | | | | | | |
| | 4c₃ | | | | | | | |
| Mechanical Buckling | 6a | PLLA | HFIP | 5 | 11.7 | 0.86 × 10⁴ | 30 | 85.5 |
| Coils and Folds | 6b | PLLA | HFIP | 5 | 6.4 | 1.56 × 10⁴ | 81.6 | 156 |
| | 6c | PLLA | HFIP | 5 | Out of plane buckling by folding | | | |
| | 6d | PLLA | HFIP | 5 | 6.4 | 1.56 × 10⁴ | 60 | 156 |
| | 7 | PLLA | HFIP | 5 | Transitional buckling modes | | | |
| | 8a | Nylon-6 | HFIP/FA | 10 | | | | |
| | 8b | Nylon-6 | HFIP/FA | 10 | 2.6 | 7.57 × 10⁵ | 31.4 | 385 |
| | 8c | Nylon-6 | HFIP/FA | 10 | Superimposed buckling modes | | | |
| | 8d | Nylon-6 | HFIP/FA | 10 | 8.5 | 4.47 × 10⁵ | 34.7 | 118 |
| | 8e | Nylon-6 | HFIP/FA | 10 | 20.18 | 4.26 × 10⁵ | 44.8 | 49.6 |

Lateral velocity of the collector is 0.1 m/s

From these tests, one can see that there is one transition stage where the straight jet transferred into bent coiled loops. The high speed camera images at below showed the start and develop of the electro-driven bending instability from a straight electrospinning jet.

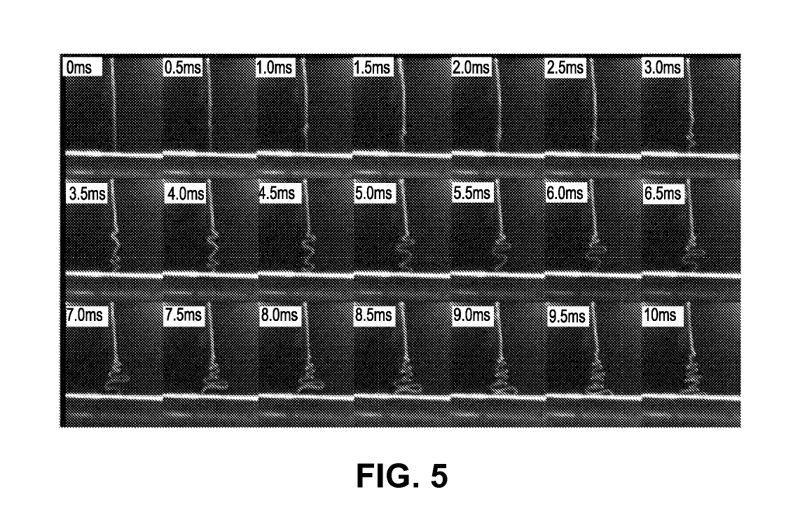

The PEO aqueous solution held in the pipette is connected to the power supply. The distance from the orifice to the collector is 53 mm. The high frame rate camera is used to observe the jet path. The straight segment of the jet extends from the orifice to the collector when the voltage is set at 5.5 KV. Then after the second frame, the voltage is reduced in a short time to 5.4 KV. The reduced voltage leads to a thinner jet which has lower bending stiffness. The electrical bending instability begins to form about 36 mm below the orifice (FIG. 5, 0.5 ms). In 1.5 ms the instability is carried down to about 43 mm (FIG. 5, 2.0 ms). At 3.0 ms a new electrical bending instability occurs at about 30 mm (FIG. 5, 3.0 ms). At 4.5 ms, the coils of the first electrical bending instability are about to move out of the field of view. A new instability develops at about 30 mm (FIG. 5, 4.5 ms) and develops more fully. At 6.0 and 7.5 ms, the electrical bending instability starts at 30 mm and moves downward at a velocity of 4 m/s (FIG. 5, 6.0 ms and 7.0 ms). From this series of images it is found that the frequency of the electrical bending instability is in the range of 10³ to 10⁴ Hz. If the voltage is increased to 5.5 KV, the onset of the electrical bending instability moves downward and the straight segment reaches to the collector.

As is noted above, the diameter of the spinneret is 160 μm. The fiber forming composition is a 6 weight percent polyethylene oxide (PEO)/water solution, where the molecular weight of the PEO is 400,000 g/mole. The distance from the spinneret to the collector is 53 mm, while the voltage between the spinneret and the collector is applied as a function of time as shown in FIG. 5.

The periodic buckling of a fluid jet incident on a surface is a striking fluid mechanical instability. Physically the reason for the buckling of a viscous jet can be attributed to the fact that a viscous jet may be either in tension or compression, depending on the velocity gradient along its axis. If axial compressive stresses along the jet reach a sufficient value, it would produce the fluid mechanics analogue to the buckling of a slender solid column. In the electrospinning process, the buckling instability occurs just above the collector where the electrospinning jet is in compression as it encounters the collector surface.

The Reynolds number and the distance, between the orifice and the flat collector, called the fall height are two parameters that determine the onset of buckling in a gravity driven jet. When the Reynolds number of the liquid is larger than 1.2, the critical Reynolds number, the jet is stable and buckling does not occur. If the experimental fall height is less than the critical fall height, no buckling occurs. Folding and coiling are two kinds of buckling instabilities. Jets of circular cross-section first fold. At a greater length the same jet begins to coil. Planar jets (ribbons) only fold when they become unstable and buckle.

As shown in FIG. 5, from left to right the collecting distance increased and the electrospinning jet started as straight jet and gradually became the bent coiling loops. The buckling instabilities occur all the way along the fiber, and the buckling forms coils. The size of these coils maintain a narrow range of diameters of about 10 μm. Buckling instability happens in both straight electrospinning jets and electrically bent electrospinning jet. The characteristic sizes of the buckling coiling are in 10 μm range before and after the electrical bending instability develops. This corresponds to the dramatically changing velocity of the jet when it reaches the collector.

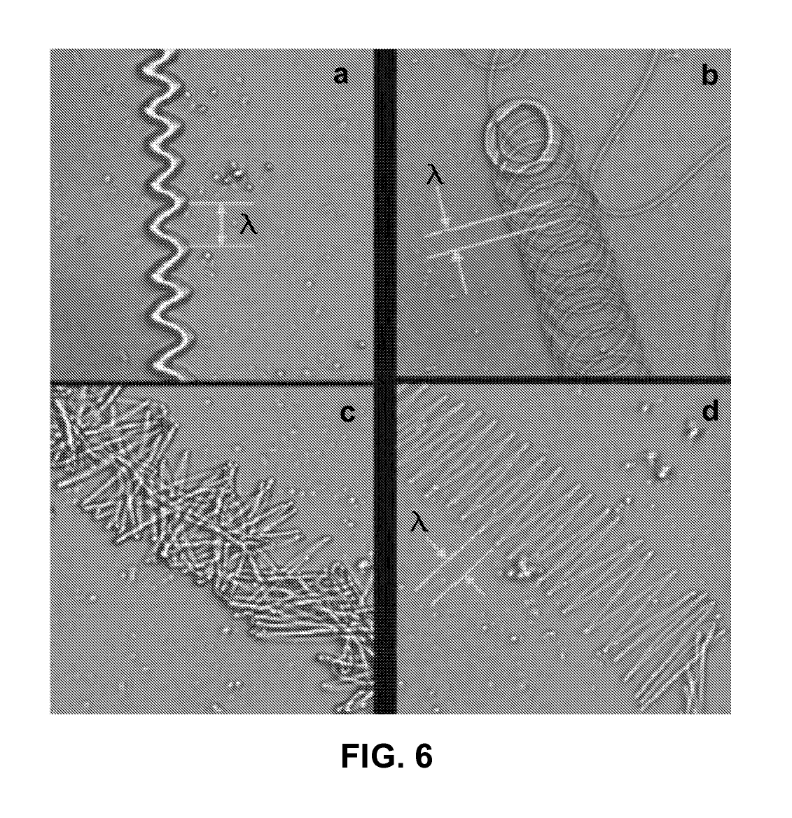

FIG. 6 shows optical microscope pictures of buckled electrospun PLLA fibers and the different buckling instabilities contained in the PLLA electrospun fibers. For these pictures poly(L-lactide) (PLLA), from Sigma-Aldrich and having a molecular weight (Mw) of 52,000 g/mol is dissolved in hexafluoroisopropanol (HFIP) to make a 5 weight percent solution. The PLLA solution is held in a capillary which is connected to a high voltage power supply. The inner diameter of the capillary is 160 μm. The distance from the capillary tip to the grounded collector is 20 mm; the voltage is 1500 V. Under these conditions, the electrical bending instability did not take place and only a straight electrospinning jet is produced. The electrospun fibers collected on the microscopy glass slides are observed using the optical microscopy. As shown in FIG. 6, zigzag folding and helical coiling are contained in one continuous electrospun PLLA fiber. The sinusoidal folding is showed in FIG. 6a. The helical coiling is shown in FIG. 6b. Zigzag folding is shown in FIG. 6c and FIG. 6d.

FIG. 7 shows buckling phenomena observed in the PLLA fibers made from the straight segment of an electrospinning jet. In this instance, the PLLA solution, held in the spinneret, is connected to high voltage power supply. The inner diameter of the capillary is 160 μm. The distance from the capillary orifice to the grounded collector is 20 mm. The collector is moved at 0.1 m/s. The voltage is 1500 V. Under these conditions, the electrical bending instability did not occur and only the straight path of the jet is observed. The buckled fibers collected on glass microscope slides are observed using optical microscopy. The amount of the charge carried by these fibers is quickly dissipated by the surface conductivity of the glass. Sinuous folding, zigzag folding and helical coiling occurs. The wave lengths of the buckles are about 6 to about 30 μm. The frequencies are around 104 Hz. See Table 1 for additional data.

Yarin et al. (Journal of Fluid Mechanics, Vol. 253, 593 (1993) and Journal of Fluid Mechanics, Vol. 307, 85, (1996)) calculated the buckling frequency of a viscous jet or ribbon impinging on a plate. They derived the relationship between the buckling frequency and the properties of the fluid and flow (viscosity, flow rate, density, dimension of the jet and the external force per unit mass). From their calculated curve, one can locate the buckling frequency of the electrospinning jet in the experiments of the present invention. The results show the buckling frequency of electrospinning jet is in the range of 10⁴ to 10⁶ Hz which agrees with the observations. The observed buckling frequency of an electrospinning jet is about 2 to 3 orders higher than the frequency associated with the electrical bending instability, which is in the range of 10³ Hz.

A moving collector inclined by only 5 degrees is used to collect one single electrospun Nylon-6 fiber, which exhibits different morphologies formed at slightly different collector distances. Nylon-6 nanofibers are electrospun from an orifice at the orifice of a pipette that has an orifice diameter of 160 μm. The height of the column of solution above the orifice is about 3 cm, so the hydrostatic pressure inside the orifice is about 200 Pa (N/m²). The pressure does not change significantly during an experiment.

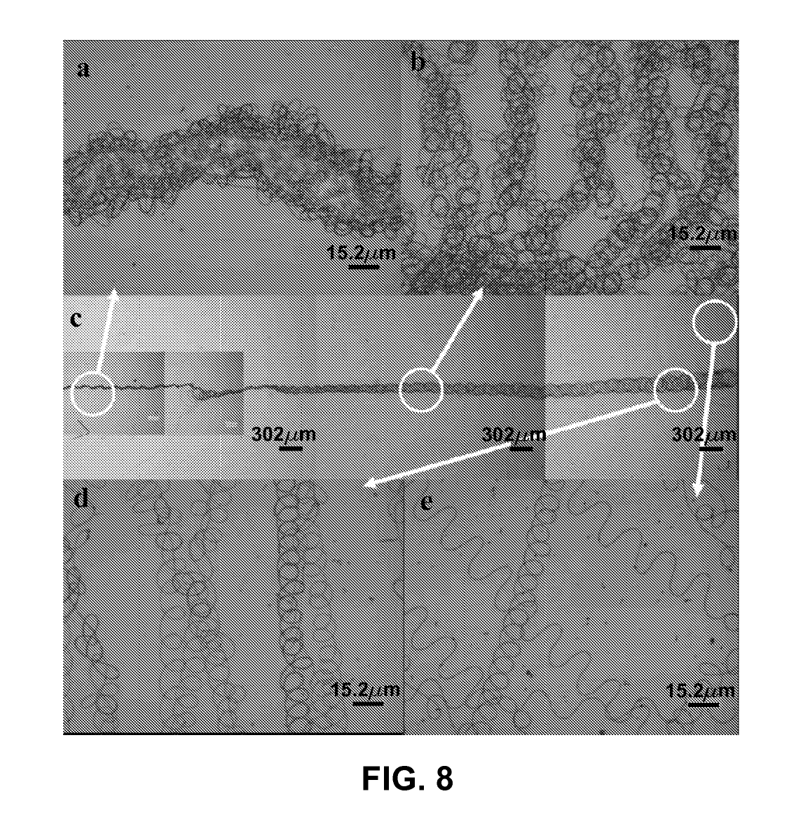

The electrospun fiber, collected on the glass microscope slide, is observed with an optical microscope. Five images are fitted together to create the composite in FIG. 8. The collection distance increases from about 1 mm to about 75 mm as the inclined collector is moved laterally. The nearly straight electrospinning jet formed a complex network of small loops that waver slightly, as shown at higher magnification in FIG. 8a. The second small block from the left edge of FIG. 8c shows the onset of a bending instability coil with loops having relatively large diameters which gradually shrink and then expand to a diameter to over 200 μm at the location of the image in FIG. 8b. This image shows the presence of many 15 μm diameter coils formed by buckling that occurs when the jet is stopped on the collector. FIG. 8d shows similar buckling coils superimposed upon the larger diameter electrical bending coils typical of the region indicated by the tail of the arrow in the upper right corner. Near the right edge of FIG. 8c, even larger coils due to the electrical bending are observed. The enlarged image shown in FIG. 8e shows coils and sinuous paths caused by buckling. The buckling instability occurs both before and after the electrical bending instability develops, and produces coils or sinuous features a little less than 15 μm in scale, near the region shown in FIG. 8a and a little more than 15 μm near the region shown in FIG. 8e. See Table 1 for additional data.

For the results shown in FIG. 8, Nylon-6, purchased from Sigma-Aldrich, is dissolved in HFIP and formic acid mixture to make a 10 weight percent solution of HFIP and formic acid, having a weight ratio of 8:2. The diameter of the spinneret is 160 μm. The voltage is 3 KV, while the distance from the spinneret to the collector is changed from 1 mm to 75 mm. The electrospun fibers collected on the microscopy glass slides are observed using the optical microscopy. The PLLA fiber buckles in several modes, including coiled at the top, zigzag at the bottom, and some transitional forms in between. The length of the horizontal edge of the image is 0.7 mm.

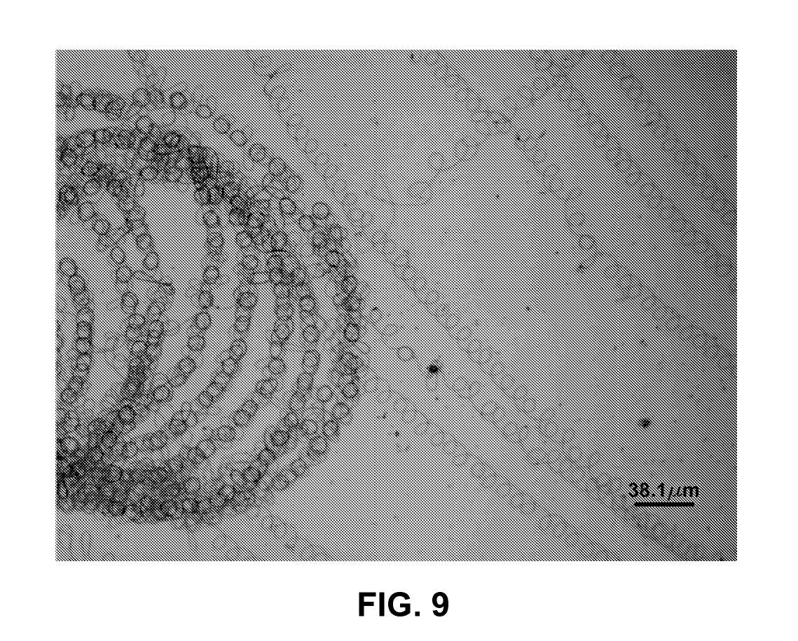

FIG. 9 shows buckling coils of Nylon-6 nanofibers superimposed on coils from the electrical bending instability. The buckling coils have nearly uniform diameters of around 15 microns. The coils from the electrical bending instability have increasing diameters that are much larger.

The coiling and buckling fibers can be collected and can be used per se or as additives in biomedical applications such as filler compositions or devices used to fill cranial aneurisms, aortal holes, arterial grafts, and the like. The knit-like fabric will have physical properties of conglutinated coils which are useful for such applications. The coils and irregularity will provide surfaces which will facilitate the blocking or plugging of the hole and facilitate growth to stabilize the plugging function. Further, the coiling and buckling fibers can be further treated using textile weaving techniques, be used in multiple layers, or joined between other layers, to form multiple dimensional arrays, including by three dimensional weaving processes. Yet further, the coiled and buckling fibers can be coated with electrically conducting materials, metals, magnetic coatings, and the like, to provide properties which will direct electromagnetic waves or photons, and such coated fibers can be used to form sheets or be arranged inside sheets to provide randomly arranged coiled structures.

An array of nanofibers/microfibers with spacing around 20 to 100 micro meters is produced. The array is made by electrical bending of an electrospinning jet. The material is Nylon-6 dissolved in formic acid (25 weight percent). Electrospinning is done at 3 KV, using a distance from the tip to the grounded collector of 5 mm, and a straight segment length of around 2 mm from the tip. The distance from the start of bending instability to the collector is around 3 mm measured from the tip. When the collected fibers are subjected to a laser as a monochromatic light source, the coherent beam produced diffraction patterns and the movement of the beam to different parts of the collected fibers produced different patterns, all of which indicated activity as a photonic device.

### Additional Embodiments

In another embodiment, the electrospinning process is utilized to produce coiled structures with controlled fiber diameter in the nanofiber to microfiber range, controlled coil diameters from less than about one micron to more than a couple of centimeters, coils with controlled or adjustable pitch (i.e., turns of the coil per unit length along the axis of the coil), control of the handedness of arrays of coils in structures which have left- and right-handed coils in useful arrays, or large arrays (0.1 mm to centimeters) of separated left- or right-handed coils.

In addition to the photonic applications, the coiled electrospun fibers of the present invention may be used in blood vessels, particularly arteries in the turns of overlapping coils are attached together at crossing points to create a wall that stretches easily until the loops are extended and the wall resists further stretching. Alternatively, the coils generated may be used to create structures and devices for holding, manipulating, transfecting, growing, and dividing living cells, particularly as parts of artificial organs, such as “scaffolds”.

The coils can be modified for certain uses to utilize their inherent electrostrictive, optical, ferromagnetic, ferroelectric, or electric properties, or properties of this sort which are created by coating the coils or selected parts of the coils with other materials which exhibit complementary properties, but need to be supported in space.

In still another embodiment, this invention can provide an attractive route to the production of large quantities of very small coils to accomplish control of electromagnetic waves with an economical low mass structure. Uses for negatively refracting structures and materials are emerging rapidly.

The use of polymer coils and/or coated polymer coils of larger dimension are suggest by J. B. Pendry in Science, Volume 306, 2004, pp. 1353 to 1355, in a paper entitled A Chiral Route to Negative Refraction, which is incorporated by reference herein in its entirety, and suggests that chiral resonances offer advantages over negative refraction structures that are currently used. Wallpaper-like arrays are described in a paper by Bingham et al. entitled Planar Wallpaper Group Metamaterials for Novel Terahertz Applications, Optics Express, Vol. 16, No. 23, pp. 18565 to 18575, which is incorporated by reference herein in its entirety.

The present invention is directed to nanofibers (“nanometer scale fibers”) made by electrospinning via utilization of an electrically driven bending instability to extend the negative refraction effects to a shorter wavelength. The principle structure is coiled fibers of polymer, coated coiled fibers of polymers (coated with electrical conductors, or metals, including magnetic coatings). The coils are supported in a structure or material with contrasting electromagnetic properties to form sheets inside which the coils are randomly arranged or are arranged in arrays to direct electromagnetic waves or photons. Electrospinning produces long regular coils, as is shown in the attached drawing. Controlling this phenomenon, or phenomena, will lead to useful negatively refracting structures. The process is useful for making uniform coils, testing for negative refraction effects, and making useful devices. The resulting sheets show negative dispersion at useful frequencies. Partial coatings in regular patterns can also be applied to the polymer cords to enhance charge interactions with photons. The coils can be made electrically conducting and/or magnetic by coating with evaporated metal, which has been shown to be a straight forward process. In another embodiment, the structures and/or fibers of the present invention can be made electrically conducting and/or magnetic by the incorporation of electrically-conductive particles and/or magnetic particles.

In one embodiment, the magnetic particles utilized in conjunction with the present invention include, but are not limited to, the magnetic particles discussed above. With regard to the electrically-conductive particles, the present invention can utilize any type of electrically-conductive particle. Such particles include, but are not limited to, particles formed from one or more electrically-conductive metals (e.g., iron, copper, gold, silver, platinum, etc.), particles formed from one or more electrically-conductive alloys, particles formed from one or more semiconductor material, particles formed from one or more graphite-containing materials, or combinations of two or more thereof. Again, the size of the particles is not limited to any specific range and thus is not critical so long as the particles can be incorporated into the fiber forming process. In one embodiment, the particles can be any size including, but not limited to, nano-sized particles. Furthermore, particles having various geometries can be utilized. Such particle geometries include, but are not limited to, needle-shaped, platelet-shaped, spherical, or a combination of any two or more different geometries.

As discussed above, the present invention can employ a way of manufacturing tiny coils with dimensions that range from less than 1 micron to a few hundred microns by controlling the electrospinning process. Also, the handedness of the coils can be controlled.

Arrays of nanofibers in three dimensions have high dielectric contrast, which can be varied by changing the ratio of the diameter of the nanofibers to the spacing between the nanofibers. While the optimal spacing is set by the wavelength of the light (500 nm, for example) to less than about 100 nm. Electrical forces inherent in electrospinning will be utilized to make photonic arrays of straight nanofibers, or arrays of coiled nanofibers that can interact with circularly polarized radiation.

The diameter of this coil is about 500 microns. Coils smaller than one micron are often found. Larger coils can be made from larger fibers or rods (i.e., coils) greater than 50 μm. The electrospinning process extends to the molecular scale, so the diameter of the smaller coil of interest can be claimed to be one nanometer.

In one embodiment, the electrically driven bending instability that occurs during electrospinning of the present invention generates coiled polymer fibers. The diameter of the coils can range from less than about ten nanometers to more than a few tenths of a meter. Such coils can be collected on a drum type winder in the form of a tube, or on a flat sheet which can be rolled into a tube. The strength and elasticity of the collected coils, on the millimeter scale, can be adjusted by controlling the diameter of the coils and the diameter of the electrospun fibers.

Further improvements can be achieved by attention to the points at which adjacent loops are in contact. If dry fibers are collected, the crossing points of fibers in adjacent turns of a coil are in simple frictional contact. This frictional contact can be made stronger if the fibers stick together at crossing points, that is, the fibers are conglutinated. Conglutination forms stronger attachments if the fibers are still fluid when they come into contact at crossing points, so control of the collection process can produce a useful range of elastic behavior, somewhat related to the elasticity of knitted fabrics, but without the complicated and delicate machines that would be required to knit fabric from nanometer scale fibers.

The conglutination process that ties turn of the coils together can also be modified by collecting a thin layer of fabric in which the fibers are not conglutinated, and then applying an even thinner layer of very fluid jets which conglutinate with every coil of solid fiber on which the fluid jet lands. This can be done be adjustment of the electrospinning process so that for a period of time dry fibers are produced, and then for a briefer time, fluid jets which solidify into fibers can be produced from the same orifice, or a different orifice. Furthermore, various solvents and adhesives can be applied by electrospinning and/or electrospraying to such structures. In another instance, laser methods, such as cutting, partial melting, photopolymerization can augment such structures.

These mechanically strong scaffolds, which combine the elastomeric properties of the fibers, which are familiar from polyurethane elastomeric fibers for example, with the elasticity associated with the bending of the fibers that is familiar in knitted fabrics, provides a way to apply time varying tensile and other forces to growing and developing cells by periodic deformation of the entire scaffold structure.

At the same time, epithelial cells and smooth muscle cells, for example, can be placed in the fluid from which the jet is fed. These cells then are carried with the jet, and with proper technique, remain viable after the jet is collected. The open structure of the collected and conglutinated coils permits buffer solutions, nutrient solutions, selective solvents, gases, and metabolic wastes to flow in and out of the structure.

The collection of the coils on a moving collector pulls the nominally circular loops into ellipsoids, or at higher collector velocities into essentially parallel and aligned fibers connected by sharp folds. The direction of the aligned fibers as they are wound into a tube can vary from a circumferential alignment, to a spiral alignment, to an axial alignment. The alignment direction can be varied as a tube is being produced. In another embodiment, small coils can be collected on the surface of a larger tube and/or fiber in order to form a structure with “soft” mechanical properties.

The individual parts of the proposed manufacturing process have all been demonstrated. In the present invention, more precise control of the fiber diameter, the coil diameter, and the degree of conglutination created at contact points is possible. The techniques for creating scaffolds for arteries with diameters from less than 0.1 millimeter to more than three millimeters are disclosed.

Blood vessels are not the only structures which can be designed and produced with uniform quality by use of the methods of the present invention. Three dimensional scaffolds containing appropriately conglutinated nanofibers, with living cells or organelles in the fibers, on the fibers, or in other small structures supported by the fibers can be designed, and new synthetic or bio-derived materials which are amenable to the use of these methods can be produced.

Other structures, designed to allow small molecules to migrate from one cell to another through a fluid can be designed and constructed via a combination of hydrophobic and hydrophilic polymers in conjunction with lipid bi-layers.

In electrospinning, jets of viscoelastic polymer solutions evolve primarily under the action of the electric forces. In particular, electrified jets experience the bending instability that is driven by the mutual repulsion of the excess electric charges carried by electrospun jets, as well as sometimes a secondary branching also rooted in charge repulsion. In some embodiments, the present invention yields deposited fibers resulting from the electrospun jets that are coiled by the electrical bending instability, as well from the straight segment of electrically driven jets which impinge onto a collector surface before electrical bending occurs. The effects of the laterally moving collector surfaces are observed. Buckling may or may not accompany bending instability of electrospun jets, but in fact, represents a totally different and distinguishable phenomenon that occurs very close to the collector.

### ADDITIONAL EXAMPLES

Materials:

Various materials are utilized including polyethylene oxide (PEO) having a molecular weight equal to 400 kDa (6 weight percent solution in de-ionized water); poly(L-lactide) (PLLA) having a molecular weight equal to 152 kDa (5 weight percent solution in hexafluoroisopropanol (HFIP)); polystyrene (PS) having a molecular weight equal to 350 kDa (25 weight percent in dimethylformamide); Nylon-6 (25 weight percent solution in formic acid (FA—88%)); Nylon-6 (10 weight percent solution in a HFIP/FA mixture with the HFIP/FA ratio being 8:2 (by weight). Nylon-6, poly(L-lactide) and all solvents are purchased from Sigma-Aldrich Co. Polystyrene and polyethylene oxide are purchased from Scientific Polymer Products, Inc. and used as received.

Experimental Stage:

The experimental setup for electrospinning is similar to the one illustrated in FIG. 2. However, the grounded collector 22 might be tilted at different angles from θ=0 to about 45° (as measured from the right-side angle of inclination). The collector might be either motionless or move horizontally at a constant speed of typically V_{c}=0 to about 3 m/s. It should be noted that the present invention is not limited to just this speed range for the collector. Instead, any suitable speed is possible including, but not limited to, speeds outside of the above range. Also, in some experiments a grounded liquid surface is used as collector. When the lateral moving inclined collector is used, the lateral motion of the collector is in the direction that causes the separation between the tip and the collector to increase.

The experiments are conducted under ambient conditions at room temperature and relative humidity of about 25%. Polymer solutions are held in a glass pipette which has a 2 cm long capillary at one end. The inner diameter of the capillary is 160 μm. A copper wire is immersed in the solution and connected with a high voltage power supply which generates DC voltages up to 13 kV. No syringe pump is used, and the flow is controlled by the outward electric pressure and the air pressure or partial vacuum applied to the surface of the liquid in the pipette. The distance between the capillary and the collector along the straight vertical line is adjusted from 0.1 to 100 cm. An ammeter is connected between the wedge-like collector and electrically grounded wire 30 (FIG. 2) to measure the current carried by the straight or electrospinning jets. Collected solidified electrospun fibers are observed with optical microscopy (Olympus 51BX) and Scanning Electron Microscopy (JEOL 5310).

Experimental Results:

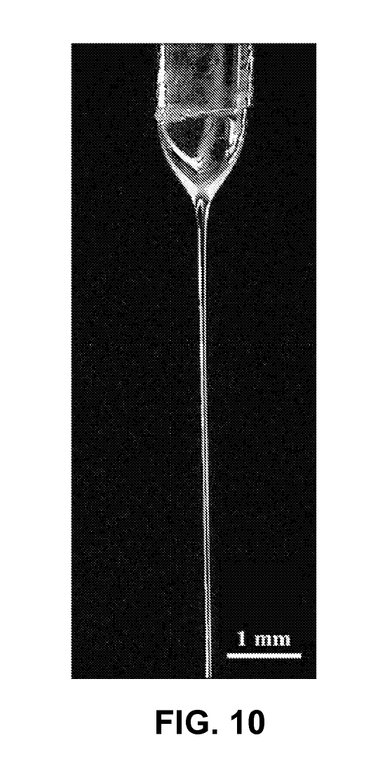

FIGS. 10 and 1 are images of two electrically driven jets sufficiently above the collecting surface. In the case of a short (for a particular polymer solution) nozzle-collector distance the jet is typically straight (FIG. 10), whereas at a longer distance (for the same solution) the jet length was sufficiently long for the electrical bending instability to occur (FIG. 1).

Buckling of Straight Electrified Jets: PEO Solution Collected on a Horizontal Moving Grounded Plate:

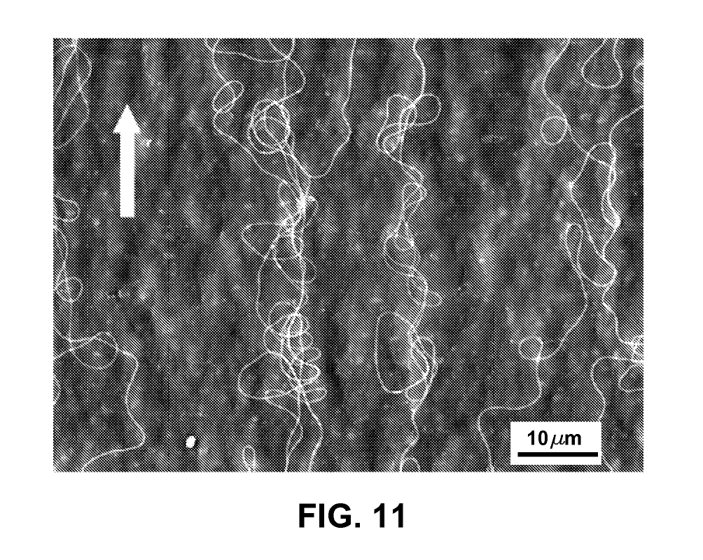

The PEO solution, held in the pipette, is connected to high voltage power supply. The distance from the capillary orifice to the horizontal grounded collector is 1 cm. The horizontal collector is moved sideways at V_{c}=0.785 m/s. The voltage is 2 kV. Under these conditions, the electrical bending instability did not occur and only a straight electrified jet is observed. In this case the relative velocity between the jet and collector Vᵣ is equal to V_{c}, since straight jets did not move sideways prior to buckling. The buckled patterns collected are observed using scanning electron microscopy. FIG. 11 shows the collected buckled PEO fibers. Sinuous folding, zigzag folding and helical coiling occurred. The rate at which the periodic patterns are created is determined from the known velocity of the substrate. The product of the frequency of the buckling instability and the distance advanced by each cycle (λ, wavelength of the deposited buckling pattern) is equal to the relative velocity between the oncoming jet and moving collector. The wavelengths (λ) of the buckled patterns are around 5 mm. The corresponding frequencies (ω=Vᵣ/λ) are around 3.42×10⁵ Hz. The morphologies of the buckled patterns found in the case of a straight electrified jet resemble those found for buckling of uncharged rectilinear jets impinging on moving plates.

Buckling of Bending Electrospun Jets: PEO Solution Collected on a Horizontal Moving Grounded Plate:

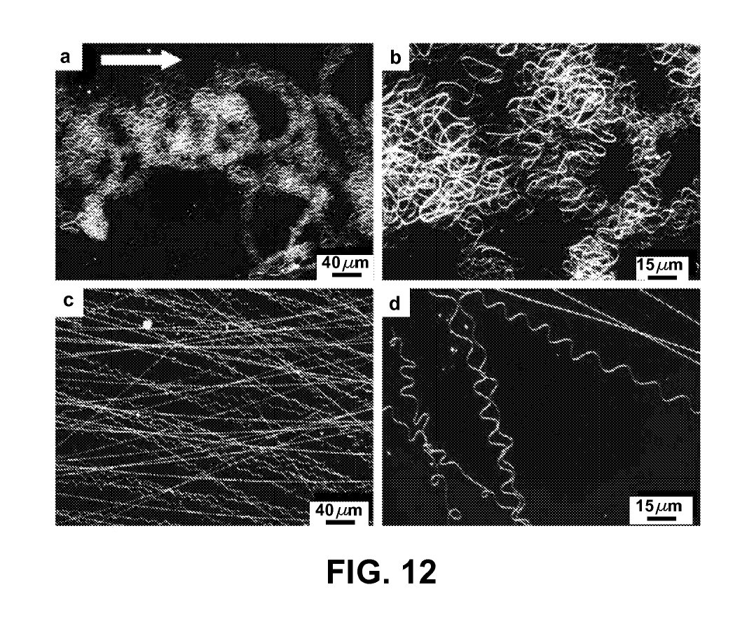

The deposits resulting from the bending and buckling electrospun jets are shown in FIG. 12. It is emphasized that they clearly demonstrate the difference between the effects of bending and buckling. The patterns associated with bending are the large loops corresponding to frequencies of the order of 103 Hz. The buckling-related patterns appear as tiny wiggles that occurred at frequencies of the order of 10⁵ to 10⁶ Hz.

The horizontal grounded collector is moving laterally at 0.01 m/s along the direction of white arrow in FIG. 12a. The distance from the tip to collector is 1.5 cm (FIGS. 12a and 12b) and 5 cm (FIGS. 12c and 12d), respectively. At these conditions, electrical bending of the jets occur prior to impingement onto the collector surface. The diameters of the bending loops at 1.5 cm inter-electrode distances ranges from 100 mm to several millimeters. The diameters of the bending loops at 5 cm interelectrode distances are several centimeters. FIGS. 12a to 12d also show that the bending loops buckled when they impinge onto the collector surface. The buckling patterns are densely piled along the path of the bending loops. The wavelengths of the buckling patterns are around 15 mm. Here, as before, we define the wavelength as the distance between adjacent identical segments of the repeating patterns. FIGS. 12a and 12b show the wavelengths of the buckling patterns are several mm. The buckling patterns, figure-eights and small circles, are densely piled along the bending loops. FIGS. 12c and 12d show that the wavelength of the buckling patterns in the wiggles are around 15 mm. The buckling patterns are loosely distributed along the bending loops, producing again sinuous waves, figure-eights and small circles. Some of the segments of bending circles in FIG. 12d are not buckled, probably because some parts of the bending circles landed in the way that there is no compressive force along them (a tangential landing), or because these segments solidified before they landed.

Buckling of Bending Electrospun Jets: PEO Jets onto an Inclined Moving Collector:

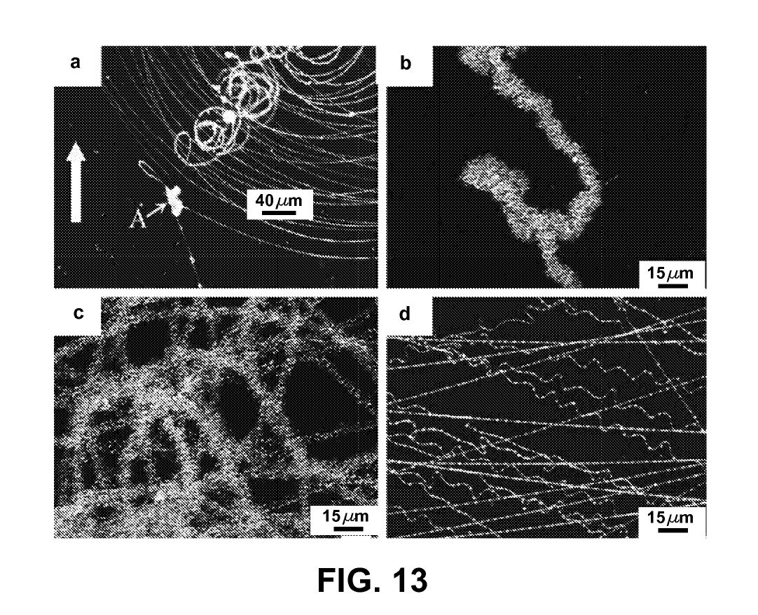

A moving grounded collector wedge with an inclination of θ=5° is used to collect electrospun PEO jets electrically bent into coils which buckle at the collector. The voltage between the spinneret and collector is 3 kV. Since the inter-electrode distance increases with time due to the lateral motion of the inclined collector, different features of the electrical bending circles and buckling patterns are collected along the slope of the moving collector (FIG. 13). FIG. 13a shows the large-scale loops originating from the electrical bending instability corresponding to a relatively short inter-electrode distance. The fluid jet accumulates into a droplet near point A in FIG. 13a as the motion started, and then deposits small bending circles which buckles on a scale that can barely be seen in FIG. 13a. The bending circles rapidly become larger in diameter and the piled rows of buckling patterns form the patterns shown in FIG. 13b. This figure details the buckling patterns superimposed on the very first bending loops. FIG. 13c shows the bending loops with the superimposed buckling patterns corresponding to the intermediate interelectrode distances. FIG. 13d shows the bending loops with the superimposed buckling patterns corresponding to the largest inter-electrode distance. The above-mentioned figures demonstrate that the buckling frequency and wavelength both vary with the inter-electrode distance. This results from the fact that as the inter-electrode distance increases, the impinging jet becomes thinner, acquires a higher velocity, and has different rheological parameters, due to solvent evaporation. So the buckling frequency is higher at shorter collecting distances and lower at larger distances. As a result, the piled buckling patterns are more densely packed at the shorter interelectrode distances and more loosely packed at the larger distances.

Buckling of Straight Electrified Jets: PLLA Jets Collected on a Horizontal Moving Grounded Plate:

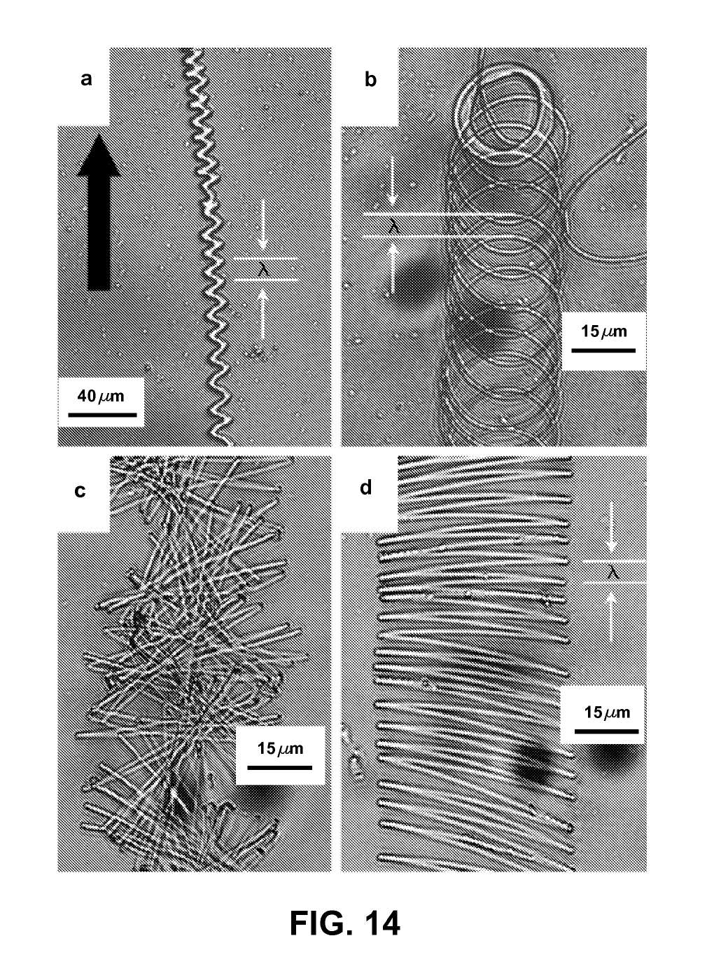

The PLLA solution described above in this section is used. The distance from the capillary orifice to the grounded collector is 2 cm. The collector is moved laterally at 1 m/s. The applied voltage is 1.5 kV. Under these conditions, for this particular polymer solution the electrical bending instability does not occur and the path of the jet toward the collector is straight. Near the collector the jet buckles. The deposited and solidified buckled patterns collected on glass microscope slides are observed using optical microscopy. The charge carried by the jet is quickly relaxed due to the surface conductivity of the glass. FIG. 14 shows the solidified buckled patterns produced from the straight PLLA jet. The diameters of the solidified PLLA fibers are around 1 to 2 μm. Sinuous patterns are shown in FIG. 14a and helical patterns are shown in FIG. 14b. Zigzag with straight segments only about 45 mm long are found in twisted rows, FIG. 14c and in flat arrays, FIG. 14d.

For such patterns the micrographs allow measurement of the corresponding wavelength I (cf. FIGS. 14a, 14b and 14d). The measured wavelengths are around 6 to 12 μm. The corresponding frequencies ω defined as ω=Vᵣ/λ (with Vᵣ being the lateral velocity of the collector V_{c}, since the straight jet did not have any lateral motion of its own) are around 0.83×10⁵ to 1.67×10⁵ Hz. In some cases (FIG. 14c) the buckled deposits are rather chaotic, so that it is impossible to ascribe them to any λ. The buckling patterns produced by the straight electrified jets resemble those found for buckling of uncharged rectilinear jets impinging on moving plates.

Buckling of Straight Electrified Jets: Polystyrene Jets onto a Horizontal Moving Grounded Plate:

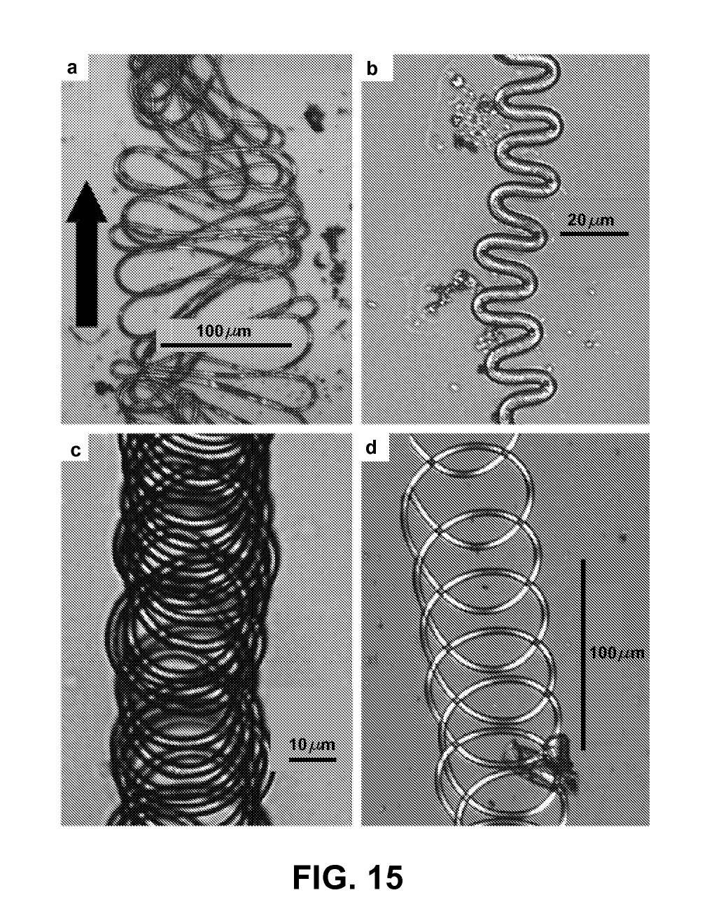

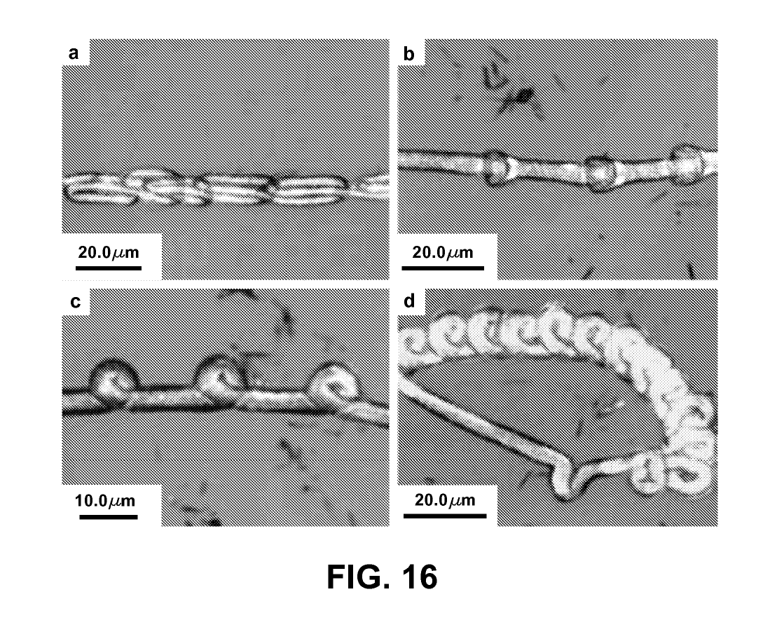

The polystyrene solution described in this section above is used. The distance from the tip to the collector is 2 cm. The collector is moved laterally at 2 m/s. The voltage is 3 kV. Under these conditions, the electrical bending instability did not occur and only a straight jet is observed. The axial velocity of the jet is around 2 m/s before it impinged onto the collector surface. The solidified buckled patterns collected on a glass slide are observed using optical microscopy. FIGS. 15 and 16 show the pattern observed on buckled polystyrene jets. The diameters of the jets are around 2 to 6 μm. Figure-eight (FIG. 15a), sinuous folding (FIG. 15b), helical coiling (FIG. 15c) and overlapping script-like “e” (FIG. 15d, FIGS. 16c and 16d) are observed. Also “paper clip chain” (FIG. 16a), and “knee-like” (FIG. 9b) patterns are formed under some circumstances. The wavelengths are measured from the micrographs and are found to be around 6 to 30 μm. The corresponding frequencies are around 0.67×10⁵ to 3.3×10⁵ Hz.

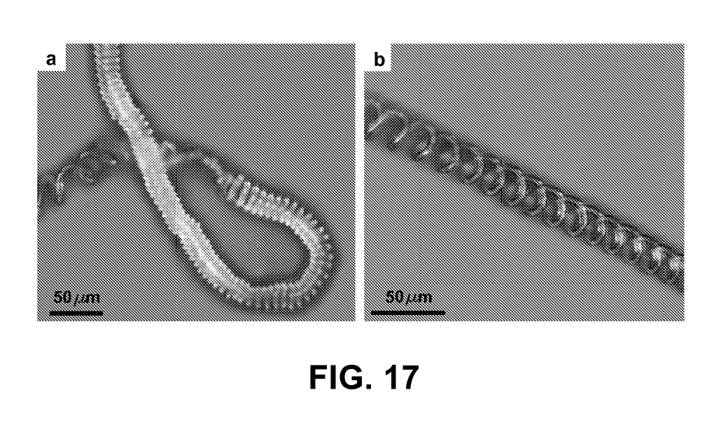

In some experiments a stationary water surface is used as a collector. The straight jet buckled as it impinged onto the surface and then sank into the water. Three-dimensional buckling morphologies are shaped as a coiling spring (FIG. 17). The diameter of the three-dimensional coil is around 20 μm.

Buckling of Bending Electrospun Jets: Nylon-6 onto an Inclined Moving Collector:

A moving collector with an inclination of θ=18.5° is used to collect electrospun jets of Nylon-6 (10 weight percent in an 8:2 mixture of HFIP and FA). The simultaneous evolution of the electrical bending and buckling is observed, see FIG. 8. The direction of the collector motion is shown by the bold black arrow in FIG. 8c. Since the inter-electrode distance increased from about 0.1 to about 7.5 cm with time due to the motion of the inclined collectors, different patterns are observed along the collector surface (FIG. 8). FIG. 8c is an overall view of the deposited fiber along the wedge slope. Four sections of the overall view are enlarged in FIGS. 8a, 8b, 8d and 8e as is shown by white arrows in FIG. 8. The nearly straight segment of the jet formed a complex, sinuous network of smaller loops, as shown at higher magnification in FIG. 8a. At a larger inter-electrode distance, the bending instability produced loops 200 μm in diameter with superimposed, much smaller, buckling patterns that were 15 μm in diameter, as is seen in FIG. 8b and FIG. 8d. Near the right edge of FIG. 8c, parts of larger coils formed by the electrical bending are observed. The enlarged image shown in FIG. 8e shows coils and sinuous patterns caused by buckling. FIG. 8c shows that the buckling instability occurred both before and after the electrical bending instability developed, and produced coils or sinuous patterns with diameters a little less than 15 μm, in the region shown in FIG. 8a and a little more than 15 μm in the region shown in FIG. 8e.

Discussion:

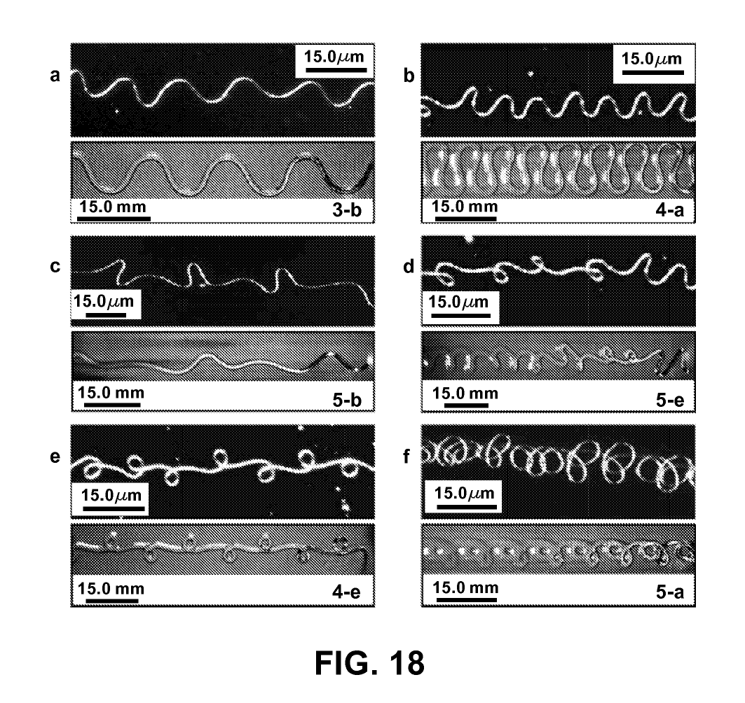

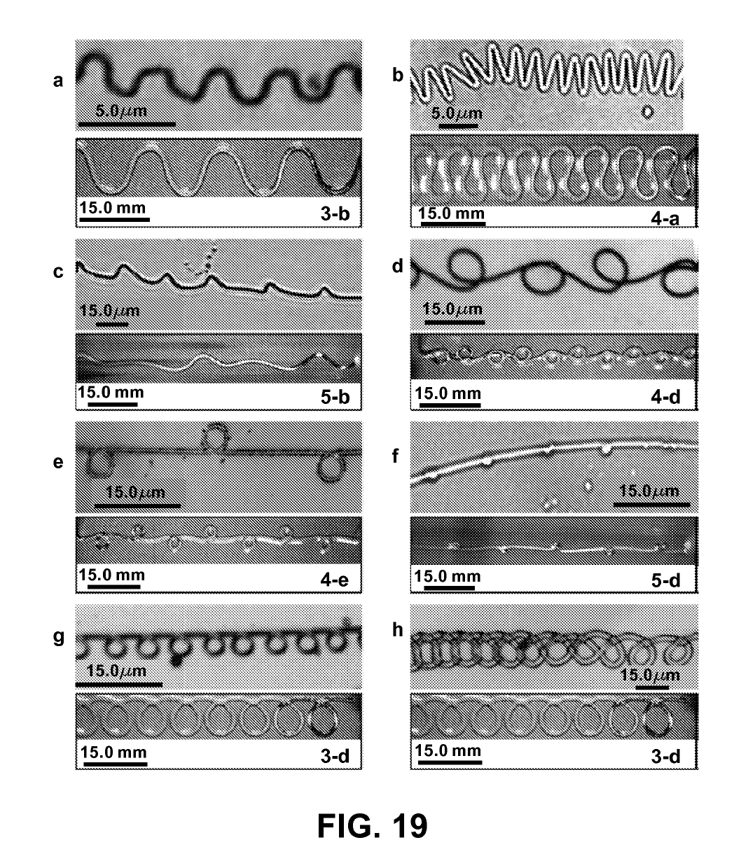

The experimental data presented above shows that the deposited buckling patterns of the electrified jets have reproducible characteristics that are similar to those found previously in uncharged jets collected by impingement on a moving hard flat surface irrespective of whether the electrically driven jet is straight or bent prior to interaction with the collector. Similarities between charged and uncharged buckling jets are clearly apparent (cf. FIGS. 18 and 19 for polyethylene oxide and Nylon-6, respectively). For the uncharged jets it is shown that the characteristic buckling frequency is not significantly dependent on the velocity of lateral motion of an obstacle, being in fact the same as for a motionless collector. Therefore, the predicted buckling frequencies for the impingement of the uncharged jet onto a motionless plate can be directly compared with those measured for a charged jet impinging on a moving collector in the present invention. The theoretical results for the buckling frequency are shown in FIG. 18b. They may be fitted by the following formula:

$$log ( ω \frac{d}{V} ) = - 0.0194 log ( \frac{μ Q}{ρ {gd}^{4}} ) = 0.2582$$

where ω is the buckling frequency in Hz, d is the jet diameter, V is the jet velocity normal to the collector, Q is volumetric flow rate in the jet, ρ and μ are the density and viscosity of the liquid. In the present context g is the external force per unit mass (the electric force per unit mass). Buckling is a low-speed and low-strain-rate phenomenon. Therefore, in this limit viscoelastic behavior reduces to Newtonian behavior with p being equivalent to the zero-shear viscosity.

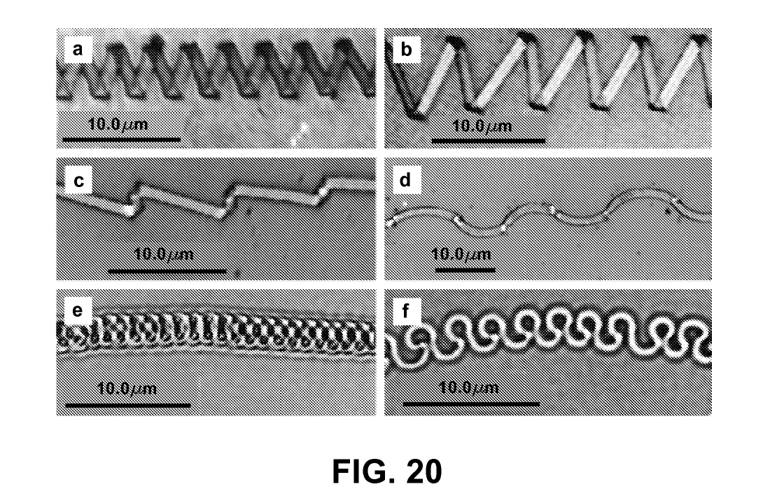

In the comparison below, d and V in the Equation above are evaluated for the segment of the jet near the collector, and used to find ω_{calculated} using the other parameters corresponding to specific experiments. In addition, the values of ω_{measured} are independently measured using the deposited patterns, as described above. Comparisons of ω_{calculated} and ω_{measured} are presented in Table 2 with data from FIGS. 8 and 11 through 20 for polyethylene oxide, PLLA, polystyrene and Nylon-6. The Equation is used to calculate the values of ω_{calculated} in all the cases. It is emphasized that the values log(ω(d/V)) and log(μQ/ρgd⁴) for the electrified jets in the present work extrapolate outside the range covered by the theoretical data fitted by the above Equation. Nevertheless, the comparisons in Table 2 show reasonable agreement between the predictions based on the Equation above and the current experimental data.

TABLE 2

| | Diameter of | | | | | | Velocity of |
|---|---|---|---|---|---|---|---|
| | the Fiber (d) | Wavelength | | Frequency (ω) 10⁵ Hz | | Fiber Length | the Collector |
| Figure | μm | (λ) | Cycles/mm | Measured | Calculated | per Cycle^{c} | m/s |
| 11 | 0.2 | 5 | 200 | 3.4 | 7.0 | 23 | 0.785 |
| 12a | 0.3 | 5 | 200 | 2.0 | 4.7 | | |
| 12b | 0.3 | 5 | 200 | 2.0 | 4.7 | | |
| 12c | 0.2 | 15 | 67 | 2.7 | 28.0 | 25 | 4.00^{a} |
| 12d | 0.2 | 15 | 67 | 2.7 | 7.0 | 25 | 4.00^{a} |
| 13c | 0.3 | 5 | 200 | 2.0 | 4.7 | | |
| 13d | 0.2 | 15 | 67 | 2.7 | 7.0 | 18 | 4.00^{a} |
| 14a | 3.8 | 14 | 71 | 0.7 | 0.4 | 25 | 1.00 |
| 14b | 1.0 | 7 | 143 | 1.4 | 1.4 | 82 | 1.00 |
| 14c | 1.0 | 1.5 | 667 | 6.7 | 1.4 | 60 | 1.00 |
| 14d | 1.1 | 4.8 | 208 | 2.1 | 1.3 | 60 | 1.00 |
| 15a | 2.4 | 17 | 59 | 1.2 | 1.2 | 334 | 2.00^{b} |
| 15b | 3.9 | 12.3 | 81 | 1.6 | 0.7 | 41 | 2.00^{b} |
| 15c | 2.4 | 3.2 | 312.5 | 6.2 | 1.2 | 52 | 2.00^{b} |
| 15d | 2.4 | 30 | 33 | 0.7 | 1.2 | 100 | 2.00^{b} |
| 16a | 2.7 | 12 | 83 | 1.7 | 1.0 | 79 | 2.00^{b} |
| 16b | 4.4 | 23 | 43 | 0.9 | 0.6 | 31 | 2.00^{b} |
| 16c | 3.9 | 18.5 | 54 | 1.1 | 0.7 | 44 | 2.00^{b} |
| 16d | 4.4 | 9 | 111 | 0.2 | 0.6 | 36 | 2.00^{b} |
| 17a | 6.4 | 8 | 125 | 2.5 | 0.4 | 73 | 2.00^{b} |
| 17b | 6.4 | 8 | 125 | 2.5 | 0.4 | 73 | 2.00^{b} |
| 8b | 0.45 | 2.6 | 385 | 3.8 | 6.2 | 31 | 1.00^{a} |
| 8b | 0.4 | 8.5 | 118 | 5.9 | 7.0 | 35 | 5.00^{a} |
| 8e | 0.35 | 20.2 | 50 | 5.0 | 8.0 | 45 | 10.00^{a} |
| 18a | 0.2 | 13 | 77 | 1.5 | 3.5 | 19 | 2.00^{a} |
| 18b | 0.2 | 8.4 | 119 | 2.4 | 3.5 | 17 | 2.00^{a} |
| 18c | 0.2 | 30.6 | 33 | 6.5 | 3.5 | 46 | 2.00^{a} |
| 18d | 0.2 | 12 | 83 | 1.7 | 3.5 | 19 | 2.00^{a} |
| 18e | 0.2 | 10 | 100 | 2.0 | 3.5 | 19 | 2.00^{a} |
| 18f | 0.2 | 4.2 | 238 | 4.8 | 3.5 | 21 | 2.00^{a} |
| 19a | 0.3 | 3.4 | 294 | 5.9 | 9.3 | 5.3 | 2.00^{a} |
| 19b | 0.8 | 2.4 | 417 | 8.3 | 3.5 | 11 | 2.00^{a} |
| 19c | 1.2 | 23 | 43 | 0.9 | 2.3 | 26 | 2.00^{a} |
| 19d | 0.7 | 21 | 48 | 1.0 | 4.0 | 49 | 2.00^{a} |
| 19e | 0.5 | 20 | 50 | 1.0 | 5.6 | 33 | 2.00^{a} |
| 19f | 1.2 | 12 | 83 | 1.7 | 2.3 | 14 | 2.00^{a} |
| 19g | 0.9 | 5 | 200 | 4.0 | 3.1 | 10 | 2.00^{a} |
| 19h | 2.6 | 11 | 91 | 1.8 | 1.1 | 44 | 2.00^{a} |
| 20a | 1.2 | 3.2 | 312 | 6.2 | 2.3 | 10 | 2.00^{a} |
| 20b | 1.2 | 5.4 | 185 | 3.7 | 2.3 | 15 | 2.00^{a} |
| 20c | 1.0 | 8.3 | 120 | 2.4 | 2.8 | 10 | 2.00^{a} |
| 20d | 1.3 | 10 | 100 | 2.0 | 2.2 | 11 | 2.00^{a} |
| 20e | 0.45 | 1.2 | 833 | 16.7 | 6.2 | 6 | 2.00^{a} |
| 20f | 0.45 | 2.5 | 400 | 8.0 | 6.2 | 8 | 2.00^{a} |

^{a}Vᵣ: the radial velocity of a typical segment of an electrical bending coils relative to the collector. The value is determined from the high frame rate video.
^{b}V_{c}: the velocity of the collector relative to the straight electrified jet.
^{c}Fiber length per cycle is defined as the distance along the path of the jets between adjacent identical segments of the repeating patterns.

### CONCLUSIONS

Two- and three-dimensional buckling phenomena are studied in electrically charged jets impinging onto collectors moving laterally at a constant velocity. At short interelectrode distances the electrified jets are straight, whereas at larger distances the jets develop electrical bending coils characteristic of electrospinning. Both straight and electrically bent jets buckle near the contact with the collector and produce buckling patterns on the collector. In the case of bending electrospun jets the short wavelength buckling patterns are superimposed on the long wavelength electrical bending loops. The frequency range corresponding to the buckling patterns is of the order of 10⁵ to 10⁶ Hz, whereas the frequency range for the bending loops is of the order of 10³ Hz. Measured frequencies derived from observations of the buckling patterns are compared to those predicted for uncharged jets impinging on a motionless hard flat surface. A reasonable agreement of the theoretical and experimental results is found.

In one embodiment, the present invention relates to the ability to make patterns, such as coils at a rate of one turn of the coil in one microsecond offers a method to create the “resonator structures” that are the basic element of artificial dielectrics. Coils with diameters, and therefore repeat patterns in a wallpaper-like array, of around 10 microns are also possible with the present invention. The electromagnetic resonant frequency of the coils depends on the diameter of the loops, with smaller loops being resonant at higher frequencies. Electrically conducting or magnetic material that may be deposited on the coils in the form of conducting rings, or capacitor like geometries will affect the resonant frequency. In another embodiment, the electrically conducting or magnetic material can be in particular form and can be included within the fiber, or fibers, that form the coiled structures of the present invention. In one such variation of this embodiment, the particular material can be included in the fiber forming solution and/or material prior to fiber formation.

In another embodiment, the present invention enables the “writing” arrays of loops, much like a page completely filled with the letter O. Such structures can then be coated on, for example, one side with evaporated metal to make a “C” shaped coating that functions as a “split ring resonator.” Variations in the shape of the metal coating, its electrical conductivity, and its magnetic properties make it possible to achieve useful alternatives all based on the “buckled” fibers produced by electrospinning. For example, instead of or in place of the “C” shaped coating, a ring of metal can be produced by evaporating the metal from a direction perpendicular to the plane of the ring.

In light of the present invention, the electrospinning of polymer fibers offer a different set of possibilities for the detailed construction of resonators which can be made with loops having diameters from less than about 1 micron to more than about 100 microns.

In still another embodiment, structures formed in accordance with the present invention can be coated with evaporated material arriving from different directions with respect to the normal to the plane of the coils. Such a method is a very practical way for applying the coatings. Electroplating offers other options for coating. Electrostatic forces can be used to direct short fibers, nanocrystals, or colloidal particles onto the resonator structures. The coils can sequester biological cells or organelles which alter the resonant frequencies.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A method of making coiled and buckled electrospun fibers comprising the steps of:
(a) providing a solution of a polymer in a suitable solvent and a device for electrospinning fiber;
(b) providing an electrospinning device;
(c) subjecting the polymer solution to an electric field such that at least one fiber is electrospun;
(d) subjecting the jet formed by the electrospinning device to electrical bending and mechanical buckling instability to thereby form a coiled and buckled fiber; and
(e) collecting the at least one fiber on a collector, such that a fiber structure is produced.

2. The method of claim 1, wherein the coils are about 10 nm to about 500 cm in diameter.

3. The method of claim 1, wherein the coils are about 1 μm to about 500 μm in diameter.

4. The method of claim 1, wherein the coils are about 1 μm to about 50 cm in diameter.

5. The method of claim 1, wherein mechanical buckling is controlled by applying a pattern of transverse electrical fields to at an appropriate frequency to a jet as it approaches a collector.

6. The method of claim 1, wherein mechanical buckling is achieved by applying an electric field with a transverse component at a frequency of about 10⁴ to about 10⁶ Hz to said fiber.

7. The method of claim 1, wherein an electrical field of about 500 to 13,000 volts is applied between the orifice of the electrospinning device and the collector.

8. The method of claim 1, wherein the collector is placed about 0.1 mm to about 30 cm from the orifice of the electrospinning device.

9. The method of claim 1, wherein the fibers are further coated with a metal coating, a magnetic coating, or an electrically conducting coating.

10. The method of claim 1, wherein conducting particles of optically electromagnetic wave absorbing or refracting are arranged inside the coiled fiber.

11. An apparatus for electrospinning at least one polymer fiber comprising:
(i) at least one reservoir;
(ii) at least one device for electrospinning at least one fiber, the at least one device being in fluid communication with the at least one reservoir;
(iii) a mixing device for agitating the fluid within the reservoir;
(iv) a power source capable of generating an electric field in electrical communication with the at least one device;
(v) means for electrically coiling and mechanically buckling said fibers; and
(vi) means for collecting the electrospun fibers.

12. A method of making coiled and buckled electrospun fibers comprising the steps of:
(a) providing a solution of a polymer in a suitable solvent and a device for electrospinning fiber;
(b) providing an electrospinning device;
(c) subjecting the polymer solution to an electric field such that at least one fiber is electrospun;
(d) subjecting the jet formed by the electrospinning device to electrical bending and mechanical buckling instability to thereby form a coiled and buckled fiber;
(e) collecting the at least one fiber on a collector, such that a fiber structure is produced; and
(f) coating the fiber structure on at least one surface thereof with at least one coating material.

13. The method of claim 12, wherein the coating material is selected from at least one metal, at least one ceramic compound, at least one oxide compound, at least one conductive non-metal compound, or a combination of two or more thereof.

14. The method of claim 13, wherein the at least one metal is selected from copper, gold, silver, platinum, palladium, iridium, or combinations of two or more thereof.

15. The method of claim 13, wherein the at least one oxide compound is selected from one or more titanium oxides, one or more silicon oxides, one or more zinc oxides, or combinations of two or more thereof.

16. The method of claim 13, wherein the at least one conductive non-metal compound is selected from graphite.

17. The method of claim 12, wherein the coating material is selected from at least one carbon compound, at least one carbon-generating compound, carbon, or mixtures of two or more thereof.

18. The method of claim 12, wherein the coils are about 10 nm to about 500 cm in diameter.

19. The method of claim 12, wherein the coils are about 1 μm to about 500 μm in diameter.

20. The method of claim 12, wherein the coils are about 1 μm to about 50 cm in diameter.

21. The method of claim 12, wherein mechanical buckling is controlled by applying a pattern of transverse electrical fields to at an appropriate frequency to a jet as it approaches a collector.

22. The method of claim 12, wherein mechanical buckling is achieved by applying an electric field with a transverse component at a frequency of about 10⁴ to about 10⁶ Hz to said fiber.

23. The method of claim 12, wherein an electrical field of about 500 to 13,000 volts is applied between the orifice of the electrospinning device and the collector.

24. The method of claim 12, wherein the collector is placed about 0.1 mm to about 30 cm from the orifice of the electrospinning device.

25. The method of claim 12, wherein conducting particles of optically electromagnetic wave absorbing or refracting are arranged inside the coiled fiber.

26. The method of claim 12, wherein the collector is a moving collector.

27. The method of claim 12, wherein the solvent is an organic solvent.

28. The method of claim 12, wherein the solvent is an inorganic solvent.

29. A wallpaper array structure formed from the method of claim 12.

30. A resonator structure formed from the method of claim 12.

31. A method of making coiled and buckled electrospun fibers comprising the steps of:
(A) providing a solution of a polymer and at least one type of magnetic and/or electrically-conductive particles in a suitable solvent and a device for electrospinning fiber;
(B) providing an electrospinning device;
(C) subjecting the solution to an electric field such that at least one fiber is electrospun;
(D) subjecting the jet formed by the electrospinning device to electrical bending and mechanical buckling instability to thereby form a coiled and buckled fiber; and
(E) collecting the at least one fiber on a collector, such that a fiber structure is produced,
wherein the at least one fiber contains therein at least one type of magnetic and/or electrically-conductive particles.

32. The method of claim 31, wherein the coils are about 10 nm to about 500 cm in diameter.

33. The method of claim 31, wherein the coils are about 1 μm to about 500 μm in diameter.

34. The method of claim 31, wherein the coils are about 1 μm to about 50 cm in diameter.

35. The method of claim 31, wherein mechanical buckling is controlled by applying a pattern of transverse electrical fields to at an appropriate frequency to a jet as it approaches a collector.

36. The method of claim 31, wherein mechanical buckling is achieved by applying an electric field with a transverse component at a frequency of about 10⁴ to about 10⁶ Hz to said fiber.

37. The method of claim 31, wherein an electrical field of about 500 to 13,000 volts is applied between the orifice of the electrospinning device and the collector.

38. The method of claim 31, wherein the collector is placed about 0.1 mm to about 30 cm from the orifice of the electrospinning device.

39. The method of claim 31, wherein the collector is a moving collector.

40. The method of claim 31, wherein the solvent is an organic solvent.

41. The method of claim 31, wherein the solvent is an inorganic solvent.

42. The method of claim 31, wherein the magnetic particles are selected from particles formed from one or more magnetic metals, particles formed from one or more iron-bearing compounds, particles formed from one or more magnetic alloys, particles formed from one or more ferrite compounds, or combinations of two or more thereof.

43. The method of claim 31, wherein the electrically-conductive particles are selected from particles formed from one or more electrically-conductive metals, particles formed from one or more electrically-conductive alloys, particles formed from one or more semiconductor material, particles formed from one or more graphite-containing materials, or combinations of two or more thereof.

44. A wallpaper array structure formed from the method of claim 31.

45. A resonator structure formed from the method of claim 31.
